(19) United States
(12) Patent Application Publication
(10) Pub. No.: US 2024/0026124 A1
(43) Pub. Date: Jan. 25, 2024

(54) USE OF DIEUGENOL, OLIGOMERS AND/OR POLYMERS OF EUGENOL FOR STABILIZING ORGANIC MATERIALS, STABILIZED PLASTICS COMPOSITION, STABILIZER COMPOSITION AND METHOD FOR STABILIZING ORGANIC MATERIALS

(71) Applicant: FRAUNHOFER-GESELLSCHAFT ZUR FÖRDERUNG DER ANGEWANDTEN FORSCHUNG E.V., München (DE)

(72) Inventor: Rudolf PFAENDNER, Darmstadt (DE)

(73) Assignee: FRAUNHOFER-GESELLSCHAFT ZUR FÖRDERUNG DER ANGEWANDTEN FORSCHUNG E.V., München (DE)

(21) Appl. No.: 18/245,065

(22) PCT Filed: Sep. 15, 2021
(86) PCT No.: PCT/EP2021/075362

§ 371 Date: Mar. 13, 2023

(30) Foreign Application Priority Data
Sep. 15, 2020 (DE) 10 2020 124 025.2

(51) Int. Cl. C08K 5/13

(52) U.S. Cl. CPC C08K 5/13

(57) ABSTRACT

Disclosed is a method of stabilizing organic materials and plastics, wherein the method involves incorporating into the organic material or plastic a stabilizing compound selected from the group consisting of dieugenol, eugenol oligomers, eugenol cooligomers, eugenol polymers, and eugenol copolymers. A secondary antioxidant can be included further. Also disclosed are stabilized organic materials and plastics.

Organic materials such as plastics are subject to aging processes that ultimately result in a loss of the desired properties such as of the mechanical characteristic values, for example. This process, called autoxidation, leads to changes in the polymer chain, for example, in molecular weight or the formation of new chemical groups, arising from radical chain cleavages through mechanochemical processes or through UV radiation in the presence of oxygen. Stabilizers are therefore used to prevent or at least delay said aging. Important representatives of stabilizers are antioxidants, which interfere with the free radicals formed during autoxidation and thus interrupt the degradation process. A distinction is generally made between primary antioxidants, which can react directly with oxygen-comprising free radicals or C-radicals, and secondary antioxidants, which react with intermediately formed hydroperoxides (see C. Kröhnke et al. Antioxidants in Ullmann's encyclopedia of industrial chemistry, Wiley-VCH Verlag, Weinheim 2015). Typical representatives of primary antioxidants are, for example, phenolic antioxidants, amines, but also certain lactones (benzofuranones). Classes of secondary antioxidants are phosphorus compounds, such as e.g., phosphites and phosphonites, but also organosulfuric compounds, such as e.g., sulfides and disulfides in the form of long-chain alkyl derivatives. Primary and secondary antioxidants are typically frequently combined in practice, which produces a synergistic effect.

Plastics formed from fossil raw materials, such as crude oil or natural gas, are nowadays being supplemented or replaced increasingly by plastics based on sustainable raw materials, the corresponding monomers being produced via biochemical processes. It is thus also necessary to look for additives that are likewise based on sustainable raw materials. Since stabilizers and particularly antioxidants are used in practically all plastics, there is a need in particular for efficient stabilizers made from sustainable raw materials.

Basically, primary antioxidants made from sustainable raw materials, which are also occasionally used in plastics, are known. Tocopherols (vitamin E) are a typical example. Tocopherols, similarly to conventional antioxidants, have a sterically hindered phenol structure and may be used alone or in combination with secondary antioxidants (for example S. Al-Malaika, Macromol. Symp. 2001, 176, 107). Tocopherols can e.g., be isolated from natural products such as e.g., wheat germ oil, sunflower oil or olive oil. Further known phenolic antioxidants made of natural substances which were examined in plastics are, for example,
quercetin (B. Kirschweng et al., Melt stabilisation of PE with natural antioxidants: Comparison of rutin and quercetin, Eur. Pol. J. 2018, 103, 228-237)
dihydromyrecitin (B. Kirschweng et al., Melt stabilization of polyethylene with dihydromyrecitin, a natural antioxidant, Pol. Degr. Stab. 2016, 133, 192-200)
derivatives of rosmarinic acid (K. Doudin et al., New genre of. antioxidants from renewable natural resources: Synthesis and characterisation of rosemary plant-derived antioxidants and their performance in polyolefins, Pol. Degr. Stab. 2016, 130, 126-134, see annex)
tannin (W. J. Grigsby et al., Esterification of condensed tannins and their impact on the properties of poly(lactic acid), Polymers s (2013) 344-360)
curcumin (D. Tatraaljai et al. Processing stabilisation of PE with a natural antioxidant, curcumin, European Polymer Journal 49 (2013) 1196-1203 and
silymarin and silibinin (B. Kirschweng et al., Melt stabilization of polyethylene with natural antioxidants: comparison of a natural extract and its main components. Journal of Thermal Analysis and calorimetry https://doi.or g/10.1007/s10973-020-09709-5).
catechins from tea and coffee extracts (O. Olejnik, A. Masek, Bio-Based Packaging Materials Containing Substances Derived from Coffee and Tea Plants, Materials 2020, 13, 5719

WO 2020/083740 describes improvements in the use of natural phenols by synergistic compositions made of polyphenols and alditols or cyclitols.

Some of the natural phenols already examined as stabilizers in plastics also have disadvantages, however, such as e.g., an undesirable intensive coloration (for example curcumin), mixtures of different and changing compositions (for example rosmarin and other plant extracts, silymarin), inadequate long-term effect (such as e.g., tocopherol) and/or volatility.

Dieugenol (oligomers and polymers and copolymers) has not previously been used as stabilizer in thermoplastics. Document WO 2019/092359 A1, or rather Goswinus H. M. de Kruijff et al. Green Chem., 2019, 21, 481.5-4823) describes the use of dieugenol as raw material for epoxy resins. In that case, however, the phenolic group, which is essential for the effect as antioxidant, is either epoxidized or, during the crosslinking reaction of the epoxy resin, is converted reactively.

Effective stabilizers that are based on sustainable raw materials and do not have these disadvantages are thus still sought.

This problem is solved by the use of dieugenol, eugenol oligomers and/or eugenol polymers for stabilizing organic materials, in particular against oxidative, thermal and/or actinic degradation. Claim 12 relates to a correspondingly stabilized plastics composition. Claim 14 specifies a stabilizer composition. Claim 16 specifies a method for stabilizing organic materials. The dependent claims relate to advantageous embodiments.

Oligomers or polymers are also understood to be cooligomers or copolymers with other suitable monomers. It is essential here for the effect as antioxidant that in the polymers and oligomers or copolymers and cooligomers the phenolic group is maintained as active principle and in the polymer synthesis is not deactivated in a reaction, for example by condensation and conversion into an ester or ether group. Eugenol end groups, which are used in polycarbonates for further reaction and synthesis of polysiloxane copolymers, as described for example in WO 2019/228783 or WO 2020/094553, are thus not included by the present invention, since these polymers do not contain a free phenol group.

The natural-based raw material eugenol for the production of dieugenol and the eugenol oligomers and polymers are obtainable from colve oil, but also by biotechnological processes from biomass, for example based on wood.

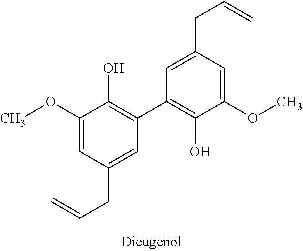

Dieugenol is produced from eugenol by oxidative coupling, for example according to F. A. Marques et al., Tetrahedron Letters 1998, 39, 943-946, M. Ogata et al. Biol. Pharm. Bull. 2005, 28, 1120-1 122, electrochemically (G. H. M. de Kruijff et al., Green Chem. 2019, 21, 4815-4823) or also enzymatically by means of Laccase (A. Llevot et al., Polym. Chem. 2015, 6. 7693-7700).

It has surprisingly been found that eugenol or its derivatives have a stabilizing effect for organic materials and in particular plastics.

The eugenol cooligomer and/or eugenol copolymer preferably comprises the repetition units A and B or is formed herefrom.

wherein the repetition unit A has the following formula:

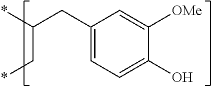

and B is at least one repetition unit derived from a radically, anionically, cationically or coordinatively polymerizable monomer, in particular ethylene, propylene, butadiene, isoprene, styrene or a styrene derivative such as e.g., alpha-methylstyrene, acrylic acid ester such as e.g., ethyl, propyl, butyl acrylate, lauryl acrylate, stearyl acrylate, methacrylic ester such as e.g., methyl methacrylate, ethyl, hydroxyethyl methacrylate, lauryl or stearyl methacrylate, acrylonitrile and mixtures and combinations hereof. Preferred radically polymerizable monomers B are, in particular, styrene, n-butyl acrylate and methyl methacrylate.

Eugenol oligomers or polymers are obtained in which there is no comonomer B present.

The use according to the invention of cooligomers and copolymers is furthermore distinguished in particular in that
the molar ratio of repetition unit A to the total of all repetition units is from 3% to 99.99%, preferably from 25 . . . to 99 . . . %, and/or
the total of repetition units A is 3 to 100 and the total of all repetition units B is 1 to 100.

An oligomer or cooligomer is understood here to mean compounds that comprise up to 10 repetition units A or A and B; a polymer or copolymer is understood to mean compounds that comprise more than 10 repetition units A or A and B.

Crosslinked structures may also possibly be present in the copolymers and are obtained by adding difunctional, trifunctional, or higher functional monomers, such as e.g., divinylbenzene or pentaerythritol tetraacrylate, but also dieugenol to the composition capable of polymerization.

Oligomers or cooligomers are preferred for the use. Dieugenol is furthermore preferred.

Here, the polymers or oligomers can be produced by a polymerization reaction via the allyl group of the eugenol, so that the phenol group is maintained largely unchanged in the oligomeric or polymeric structures.

For example, polymeric or oligomeric eugenols can be synthesized from eugenol electrochemically. Allyl compounds are polymerizable in principle by radical, controlled radical, anionic, cationic or coordination polymerization (see e.g A. Matsumoto, Polymerization of multiallyl monomers, Progress of Polymer Science, 2001, 26, 189-257). The polymerization methods are known to a person skilled in the art and can be inferred for example from relevant works, such as Ullmann's Encyclopedia of Industrial Chemistry, Polymerisation Processes, Wiley 2015. For a radical, controlled radical, cationic, anionic or coordination polymerization it is necessary firstly to provide the phenol group with a protective group by known methods, for example with an acetyl group, which is removed following polymerization or copolymerization, in the case of an acetyl group for example by hydrolysis. Oligomeric structures are generally preferably created in the case of radical polymerization with allyl groups. Copolymers are obtainable by polymerizing the eugenol provided with a protective group together with another monomer capable of polymerization, for example styrene, a styrene derivative, an acrylic acid ester or a methacrylic ester by one of the stated methods.

Furthermore, oligomeric and polymeric eugenols can be synthesized by an oxidative C—C coupling reaction, for example copper-catalyzed or enzymatically. The following polymeric structures are then obtained with n=3-100, preferably 3-10.

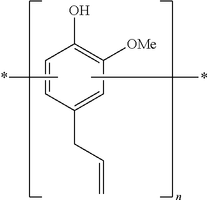

Radical, anionic, cationic or coordinative polymerization can also be used to obtain oligomeric and polymeric eugenols that have the following formula.

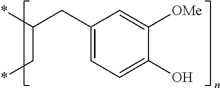

Here, n has the above-described meaning.

An oligomer is understood here to mean compounds that comprise up to 10 repetition units (n=3-10); a polymer is understood to mean compounds that comprise more than 10 repetition units.

Eugenol oligomers or eugenol polymers can also be produced for example via ZnO-catalyzed reaction (J. E. Weinberg et al., Journal of Dental Research (1972), 51, 1055-61), wherein here too a polymerization takes place substantially via the allyl groups and the phenol groups are largely maintained. A further possibility for producing eugenol (co)polymers is constituted by eugenol formaldehyde polymer novolaks (M. Shibata et al. React. Funct. Polym. 2013, 73, 1086).

All of the previously described methods for the production of eugenol polymers or dieugenol polymers or copolymers can also be used for the purpose of the present invention and are therefore included by the invention.

Since the allyl group, besides the phenol group, likewise contributes to the stabilizing effect, dieugenol is very particularly preferred.

A preferred embodiment provides for a stabilization of plastics, coatings, lubricants, hydraulic oils, engine oils, turbine oils, transmission oils, metal machining fluids, chemicals, or monomers.

The use to stabilize plastics is very particularly preferred.

Dieugenol, eugenol oligomers and/or eugenol polymers are preferably used in the organic material in a weight proportion of 0.01 to 10.00% by weight, preferably from 0.02 to 5.00% by weight, more preferably from 0.05 to 3.00% by weight, particularly preferably from 0.10 to 2.00% by weight.

Preferred plastics to be stabilized are selected here from the group consisting of:
a) polymers from olefins or diolefins such as e.g., polyethylene (LDPE, LLDPE, VLDPE, ULDPE, MDPE, HDPE, UHMWPE), metallocene PE (m-PE), polypropylene, polyisobutylene, poly-4-methyl-pentene-1, polybutadiene, polyisoprene, such as e.g., also natural rubber (NR), polycyclooctene, polyalkylene-carbon monoxide copolymers, and copolymers in the form of random or block structures such as e.g., polypropylene-polyethylene (EP), EPM or EPDM with e.g., 5-ethylidene-2-norbornene as a comonomer, ethylene-vinyl acetate (EVA}, ethylene acrylic esters such as e.g., ethylene butyl acrylate, ethylene acrylic acid and salts thereof (ionomers), and terpolymers such as e.g., ethylene acrylic acid glycidyl(meth)acrylate, graft polymers such as e.g., polypropylene graft maleic anhydride, polypropylene graft acrylic acid, polyethylene graft-acrylic acid, polyethylene-polybutylacrylate-graft-maleic anhydride and blends such as e.g., LDPE/LLDPE or also long-chain branched polypropylene copolymers which are produced with alpha-olefins as comonomers such as e.g., with 1-butene, 1-hexene, 1-octene or 1-octadecene,
b) polystyrene, polymethylstyrene, poly-alpha-methylstyrene, polyvinylnaphthalene, polyvinylbiphenyl, polyvinyltoluene, styrene-butadiene (SB), styrene-butadiene-styrene (SBS), styrene-ethylene-butylene-styrene (SEBS), styrene-ethylene-propylene-styrene, styrene-isoprene, styrene-isoprene-styrene (SIS), styrene-butadiene-acrylonitrile (ABS), styrene-acrylonitrile (SAN), styrene-acrylonitrile-acrylate (ASA), styrene-ethylene, styrene-maleic anhydride polymers including corresponding graft copolymers such as e.g., styrene on butadiene, maleic anhydride on SBS or SEBS, and graft copolymers made of methyl methacrylate, styrene-butadiene and ABS (MABS), and hydrogenated polystyrene derivatives, such as e.g., polyvinylcyclohexane, c) halogen-comprising polymers, such as e.g., polyvinyl chloride (PVC), polychloroprene and polyvinylidene chloride (PVDC), copolymers of vinyl chloride and vinylidene chloride or of vinyl chloride and vinyl acetate, chlorinated polyethylene, polyvinylidene fluoride, epichlorohydrin homo and copolymers in particular with ethylene oxide (ECO),
d) polymers of unsaturated esters such as e.g., polyacrylates and polymethacrylates such as polymethyl methacrylate (PMMA), polybutyl acrylate, polyauryl acrylate, poly stearyl acrylate, polyglycidyl methacrylate, polyacrylonitrile, polyacrylamides, copolymers such as e.g., polyacrylonitrile-poly alkyl acrylate,
e) polymers of unsaturated alcohols and derivatives, such as e.g., polyvinyl alcohol, polyvinyl acetate, polyvinyl butyral, polyallyl phthalate, polyallyl melamine,
f) polyacetals such as e.g., polyoxymethylene (POM) or copolymers with, for example, butanal, polyphenylene oxides and blends with polystyrene or polyamides,
g) polymers of cyclic ethers such as e.g., polyethylene glycol, polypropylene glycol, polyethylene oxide, polypropylene oxide, polytetrahydrofuran,
h) polyphenylene oxides and blends thereof with polystyrene and/or polyamides,
i) polyurethanes, made from hydroxy-terminated polyethers or polyesters and aromatic or aliphatic isocyanates such as e.g., 2,4- or 2,6-tolylene diisocyanate or methylenediphenyl diisocyanate, in particular also linear polyurethanes (TPU), polyureas,
j) polyamides such as e.g., polyamide-6, 6.6, 6.10, 4.6, 4.10, 6.12, 10.10, 10.12, 12.12, polyamide 11, polyamide 12 and (partially) aromatic polyamides such as e.g., polyphthalamides, for example, made from terephthalic acid and/or isophthalic acid and aliphatic diamines such as e.g., hexamethylenediamine or m-xylylenediamine or from aliphatic dicarboxylic acids such as e.g., adipic acid or sebacic acid and aromatic diamines such as e.g., 1,4- or 1,3-diaminobenzene, blends of different polyamides such as e.g., PA-6 and PA 6.6 or blends of polyamides and polyolefins such as e.g., PA/PP,
k) polyimides, polyamide-imides, polyetherimides, polyesterimides, poly(ether)ketones, polysulfones, polyethersulfones, polyarylsulfones, polyphenylene sulfides, polybenzimidazoles, polyhydantoins,
l) polyesters made from aliphatic or aromatic dicarboxylic acids and diols or from hydroxycarboxylic acids, such as e.g., polyethylene terephthalate (PET), polybutylene terephthalate (PBT), polypropylene terephthalate (PPT), polyethylene naphthylate (PEN), poly-1,4-dimethylolcyclohexane terephthalate, polyhydroxybenzoate, polyhydroxynaphthalate, polylactic acid (PLA), polyhydroxybutyrate (PHB), polyhydroxyvalerate (PHV), polyethylene succinate, polytetramethylene succinate, polycaprolactone,
m) polycarbonates, polyester carbonates and blends such as e.g., PC/ABS, PC/PBT, PC/PET/PBT, PC/PA,
n) cellulose derivatives, such as e.g., cellulose nitrate, cellulose acetate, cellulose propionate, cellulose butyrate,
o) epoxy resins, consisting of di- or polyfunctional epoxy compounds in combination with, for example, hardeners based on amines, anhydrides, dicyandiamide, mercaptans, isocyanates or catalytically active hardeners,
p) phenol resins such as e.g., phenol formaldehyde resins, urea formaldehyde resins, melamine formaldehyde resins,
q) unsaturated polyester resins from unsaturated dicarboxylic acids and diols with vinyl compounds, for example styrene, alkyd resins,
r) silicones, for example, based on dimethylsiloxanes, methyl-phenyl-siloxanes or diphenylsiloxanes, for example, terminated with vinyl groups,
s) and mixtures, combinations, or blends of two or more of the above-named polymers.

If the polymers specified under a) to r) are copolymers, they can be present in the form of random, block or tapered structures.

Furthermore, the polymers mentioned can exist in the form of linear, branched, star-shaped or hyperbranched structures.

If the polymers specified under a) to r) are stereoregular polymers, they can exist in the form of isotactic, stereotactic, but also atactic forms or as stereoblock copolymers.

Furthermore, the polymers specified under a) to r) can have both amorphous and (partially) crystalline morphologies.

Optionally, the polyolefins mentioned under a) can also be crosslinked, for example crosslinked polyethylene, which is then referred to as X-PE.

Furthermore, the present compounds can be used to stabilize rubbers and elastomers. This can be natural rubber (NR) or synthetic rubber materials such as e.g., chloroprene (CR), polybutadiene (BR), styrene-butadiene (SBR), polyisoprene (IR), butyl rubber (IIR), nitrile rubber (NBR), hydrogenated nitrile rubber (HNBR), polyester or polyether urethane rubber, or silicone rubber.

Apart from new goods, the plastics can be recycled plastics, for example, from industrial collections such as e.g., production waste or plastics from household or recyclable collections.

Furthermore preferred are in particular polymers which are produced wholly or partially from sustainable raw materials, such as e.g., polylactic acid (PLA), polylactic acid (PLA), polybutylene succinate (PBS), polybutylene succinate-co-adipate) (PBSA), poly(butylene adipate) (PBA), poly(hexamethylene succinate), polyethylene terephthalate (PET), polybutylene terephthalate (PBT), polypropylene terephthalate (PPT), polyethylene furanoate (poly(ethylene-2,5-furandicarboxylate)) (PEF), poly-3-hydroxybutyrate, poly-4-hydroxybutyrate, poly-3-hydroxyvalerate.

Furthermore preferably the organic material, in particular the plastic, comprises at least one additional additive selected from the group consisting of primary and/or secondary antioxidants, in particular primary and/or secondary antioxidants selected from the group consisting of phosphites, phosphonites, thiols, phenolic antioxidants, sterically hindered amines, hydroxylamines and mixtures or combinations thereof, UV absorbers, light stabilizers, hydroxylamine-based stabilizers, benzofuranone-based stabilizers, nucleating agents, impact modifiers, plasticizers, mold lubricants, rheology modifiers, chain extenders, processing aids, pigments, dyes, optical brighteners, antimicrobial agents, antistatic agents, slip agents, antiblocking agents, coupling agents, dispersants, compatibilizers, oxygen scavengers, acid scavengers, co-stabilizers, marking agents and anti-fogging agents, in particular secondary antioxidants, and/or is added to the plastic during the use, wherein phosphites, phosphonites, acid scavengers, hindered amines and/or combinations hereof are particularly preferred.

In the aforementioned embodiment it is advantageous if the at least one additive is contained or added in an amount of 0.01 to 9.99% by weight, preferably 0.01 to 4.98% by weight, particularly preferably 0.02 to 2.00% by weight, based on the total of the dieugenol, the eugenol oligomers and/or eugenol polymers, the organic material and the at least one additive.

The present invention furthermore relates to an organic material, in particular a plastics composition, containing dieugenol, eugenol oligomers and/or eugenol polymers as stabilizer.

Particularly advantageous is an organic material and in particular a plastics composition having the following composition:
to 10.00% by weight, preferably from 0.02 to 5.00% by weight, more preferably from to 3.00% by weight, particularly preferably from 0.10 to 2.00% by weight of dieugenol, eugenol oligomers and/or eugenol polymers,
99.99 to 90.00% by weight, preferably 99.89 to 95.00% by weight, more preferably from 97.00 to 99.95% by weight, particularly preferably 99.90 to 98.00% by weight, of at least one organic material, preferably selected from the group consisting of plastics, coatings, lubricants, hydraulic oils, engine oils, turbine oils, transmission oils, metal machining fluids, chemicals, or monomers, and
0 to 9.99% by weight, preferably 0 to 4.98% by weight, particularly preferably 0.02 to 2.00% by weight of at least one additive,
wherein the components add up to 100% by weight.

The plastics composition can be present for example in the form of injection molded parts, foils or films, foams, fibers, cables and pipes, sections, hollow bodies, ribbons, membranes, such as e.g., geo-membranes, or adhesives that are manufactured by extrusion, injection molding, blow molding, calendering, pressing processes, spinning processes, or rotomolding, e.g., for the electrical and electronic industry, the construction industry, the transport industry (automobile, aircraft, ship, railroad), for medical applications, for domestic and electric appliances, vehicle parts, consumer products, packaging, furniture, textiles. A further area of application are paints, colorants and coatings.

The at least one additive is preferably selected from the group consisting of primary and/or secondary antioxidants, in particular primary and/or secondary antioxidants selected from the group consisting of phosphites, phosphonites, thiols, phenolic antioxidants, sterically hindered amines, hydroxylamines, and mixtures or combinations thereof, UV absorbers, light stabilizers, stabilizers on a hydroxylamine base, stabilizers on a benzofuranone base, nucleating agents, toughness improvers, plasticizers, mold lubricants, rheological modifiers, chain extenders, processing aids, pigments, dyes, optical brighteners, antimicrobial active agents, antistatic agents, slip agents, anti-blocking agents, coupling agents, dispersing agents, compatibilizers, oxygen scavengers, acid scavengers, costabilizers, marking agents, and anti-fogging agents, in particular secondary antioxidants;
is in particular selected from the group consisting of a secondary antioxidant selected from the group consisting of phosphites, phosphonites, and thiols, at least one costabilizer selected from the group consisting of polyols, acid scavengers, and sterically hindered amines.

The present invention also relates to a stabilizer composition containing or consisting of
dieugenol, eugenol oligomers, eugenol cooligomers, eugenol polymers and/or eugenol copolymers and mixtures and combinations hereof, and
at least one secondary antioxidant selected from the group consisting of phosphites, phosphonites, or thiols, and/or at least one costabilizer selected from the group consisting of polyols, acid scavengers, or sterically hindered amines, and mixtures and combinations thereof.

Thus, new stabilizer compositions based on sustainable raw materials and a new method for stabilizing plastics are made possible, which have a high efficacy, are environmentally friendly and have a favorable cost structure.

With regard to specific embodiments of dieugenol, eugenol oligomers, eugenol cooligomers, eugenol polymers and/or eugenol copolymers, reference is made to the statements above.

It is preferred in the stabilizer composition if the dieugenol, oligoeugenol or polyeugenol and the at least one secondary antioxidant and/or the costabilizer are present in a ratio by weight from 100:1 to 1:100, preferably 10:1 to 1:10, particularly preferably from 4:1 to 1:4.

The present invention further relates to a method for stabilizing organic materials, in particular against oxidative, thermal and/or actinic degradation, in which dieugenol, eugenol oligomers and/or eugenol polymers are incorporated into the organic material.

In a preferred embodiment the compositions contain secondary antioxidants, in particular phosphites/phosphonites or thio compounds.

Suitable phosphites are triphenylphosphite, diphenylalkylphosphite, phenyldialkylphosphite, tri(nonylphenyl)phosphite, trilaurylphosphite, trioctadecylphosphite, distearylpentaerythritoldiphosphite, tris-(2,4-di-tert-butylphenyl)phosphite, diisodecylpentaerythritoldiphosphite, bis(2,4-di-tert-butylphenyl)pentaerythritoldiphosphite, bis(2,4-di-cumylphenyl)pentaerythritoldiphosphite, bis(2,6-di-tert-butyl-4-methylphenyl)pentaerythritoldiphosphite, diisodecyloxypentaerythritoldiphosphite, bis(2,4-di-tert-butyl-6-methylphenyl)pentaerythritoldiphosphite, bis(2,4,6-tris(tert-butylphenyl)pentaerythritoldiphosphite, tristearylsorbitoltriphosphite, tetrakis(2,4-di-tert-butylphenyl)-4,4′-biphenylene diphosphonite, 6-isooctyloxy-2,4,8,10-tetra-tert-butyl-12H-dibenz[d,g]-1,3,2-dioxaphosphocine, bis(2,4-di-tert-butyl-6-methylphenyl)methylphosphite, bis(2,4-di-tert-butyl-6-methylphenyl)ethylphosphite, 6-fluoro-2,4,8,10-tetra-tert-butyl-12-methyl-dibenz[d,g]-1,3,2-dioxaphosphocine, 2,2′2″-nitrilo[triethyltris(3,3″,5,5′-tetra-tert-butyl-1,1′-biphenyl-2,2′-diyl)phosphite], 2-ethylhexyl(3,3′,5,5′-tetra-tert-butyl-1,1′-biphenyl-2,2′-diyl))phosphite, 5-butyl-5-ethyl-2-(2,4,6-tri-tert-butylphenoxy)-1,3,2-dioxaphosphirane.

Particularly preferred phosphites/phosphonites are:

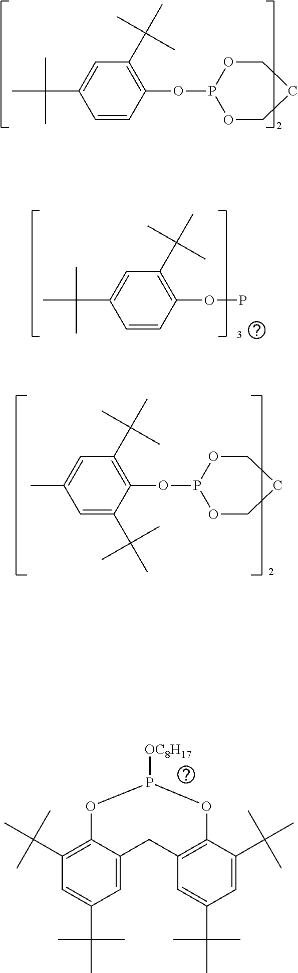

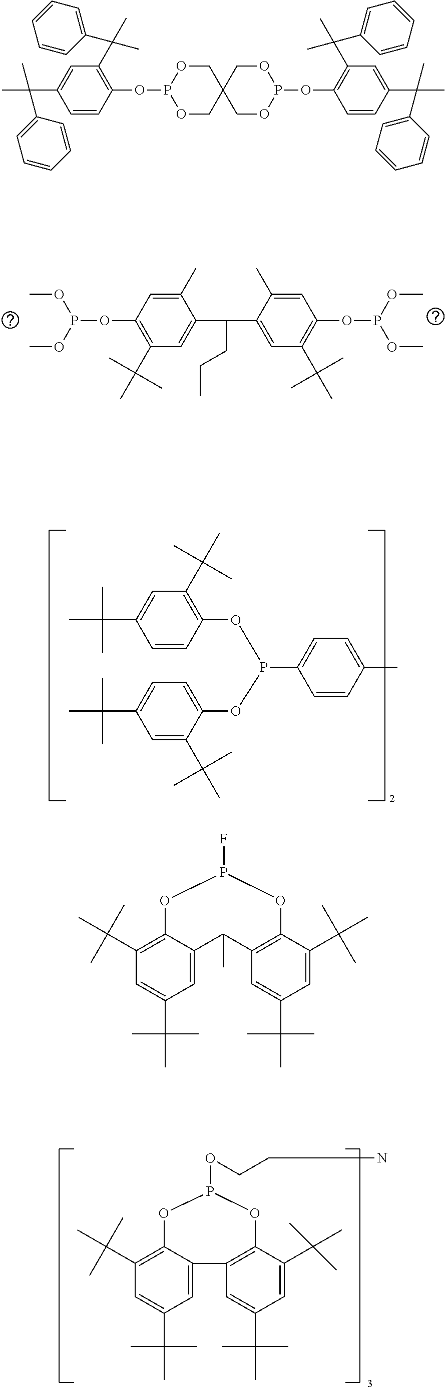

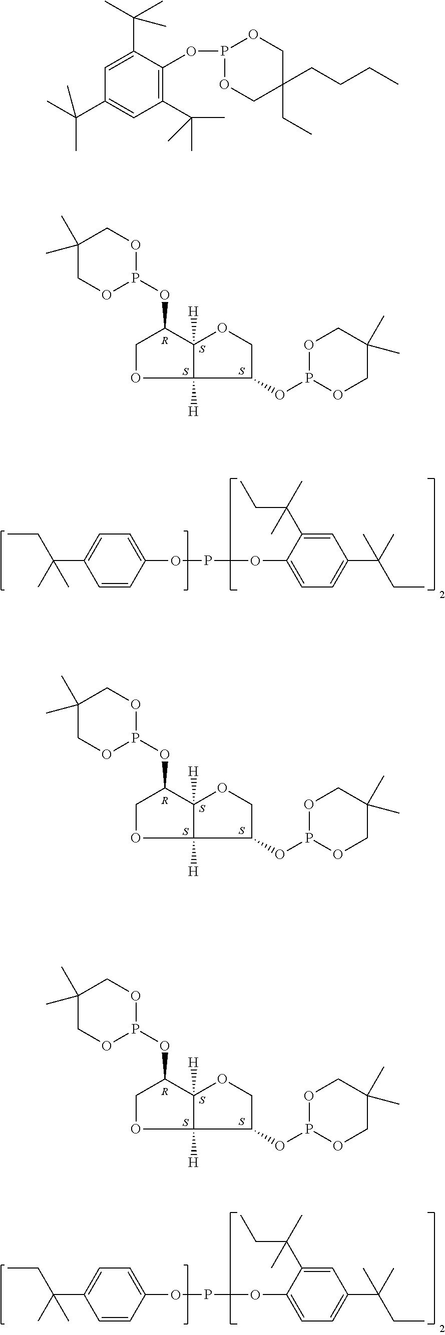

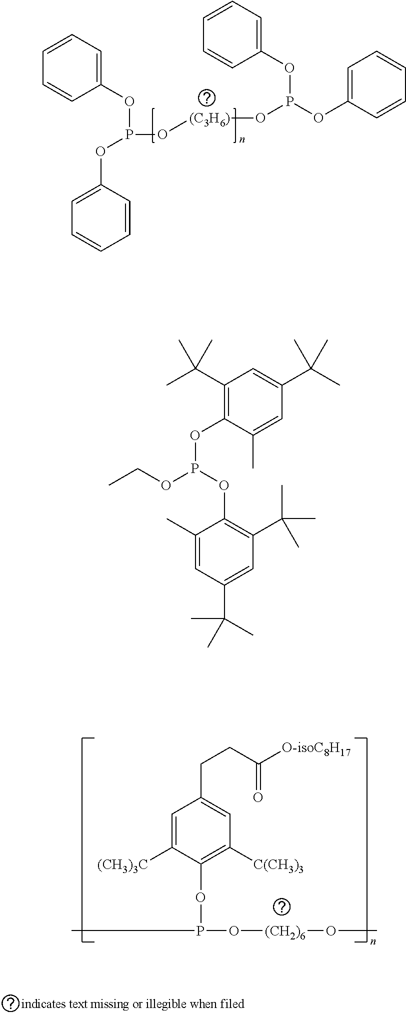

where n=3-100.

Very particularly preferably, the phosphite tris-(2,4-di-tert-butylphenyl)phosphite is used as the secondary antioxidant.

wherein n=3-100.

Very particularly preferably, the phosphite tris-(2,4-di-tert-butylphenyl)phosphite is used as the secondary antioxidant.

Suitable secondary antioxidants are furthermore organosulfur compounds such as e.g., sulfides and disulfides, e.g., distearylthiodipropionate, dilaurylthiodipropionate;

ditridecyldithiopropionate, ditetradecylthiodipropionate, 3-(dodecylthio)-,1,1′[2,2-bis[[3-(dodecylthio)-1-oxopropoxy]methyl]-1,3-propandiyl]propanoic acid ester. The following structures are preferred:

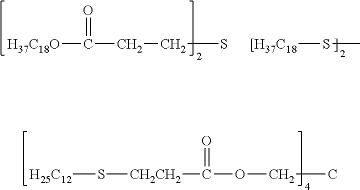

Additives can additionally be selected from the group consisting of further primary antioxidants, UV absorbers, light stabilizers, metal deactivators, filler deactivators, antiozonants, nucleating agents, antinucleating agents, impact modifiers, plasticizers, mold lubricants, rheology modifiers, thixotropic agents, chain extenders, processing aids, mold release agents, flame retardants, pigments, dyes, optical brighteners, antimicrobial agents, antistatic agents, slip agents, antiblocking agents, coupling agents, crosslinking agents, anticrosslinking agents, hydrophilic agents, hydrophobic agents, adhesion promoters, dispersants, compatibilizers, oxygen scavengers, acid scavengers, blowing agents, degradation additives, defoaming aids, odor scavengers, marking agents, anti-fogging agents, fillers and reinforcements.

In a preferred embodiment the compositions contain acid scavengers in particular.

Suitable acid scavengers (“antacids”) are salts of monovalent, bivalent, trivalent, or quadrivalent metals, preferably alkali metals, alkaline earth metals, aluminum or zinc, in particular formed with fatty acids such as e.g., calcium stearate, magnesium stearate, zinc stearate, aluminum stearate, calcium laurate, calcium behenate, calcium lactate, calcium stearolyl-2-lactate. Further classes of suitable acid scavengers are hydrolactites, in particular synthetic hydrolactites on the basis of aluminum, magnesium and zinc, hydrocalumites, zeolites, alkaline earth oxides, in particular calcium oxide and magnesium oxide and zinc oxide, alkaline earth carbonates, in particular calcium carbonate, magnesium carbonate, dolomite, and hydroxides, in particular brucite (magnesium hydroxide).

Suitable further primary antioxidants are phenolic antioxidants, amines and lactones.

Suitable phenolic antioxidants are, for example:
alkylated monophenols, such as e.g., 2,6-di-tert-butyl-4-methylphenol, 2-tert-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-dioctadecyl-4-methylphenol, 2,4,6-tricyclohexylphenol, 2,6-di-tert-butyl-4-methoxymethylphenol, linear or branched nonylphenols such as e.g., 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof;
alkylthiomethyl phenols, such as e.g., 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol;
hydroquinones and alkylated hydroquinones, such as e.g., 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxylphenyl)adipate;
tocopherols, such as e.g., α-, β-, γ-, δ-tocopherol and mixtures hereof (vitamin E);
hydroxylated thiodiphenyl ethers, such as e.g., 2,2′-thiobis(6-tert-butyl-4-methylphenol), 2,2′-thiobis(4-octylphenol), 4,4′-thiobis(6-tert-butyl-3-methyl phenol), 4,4′-thiobis(6-tert-butyl-2-methylphenol), 4,4′-thiobis(3,6-di-sec-amylphenol), 4,4′-bis(2,6-dimethyl-4-hydroxyphenyl)disulfide;
alkylidene bisphenols, such as e.g., 2,2′methylenebis(6-tert-butyl-4-methylphenol), 2,2′-methylenebis(6-tert-butyl-4-ethylphenol), 2,2′-methylenebis[4-methyl-6-(α-methylcyclohexyl)phenol], 2,2′-methylenebis(4-methyl-6-cyclhexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis(6-tert-butyl-4-isobutylphenol), 2,2′-methylenebis[6-(α-methylbenzyl)-4-nonylphenol], 2,2′-methylenebis[6-(α,α-di methylbenzyl)-4-nonylphenol], 4,4′-methylenebis(2,6-di-tert-butylphenol, 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, ethylene glycol-bis[3,3-bis(3′-tert-butyl-4′-hydroxyphenyl)butyrate], bis(3-tert-butyl-4-hydroxy-5-methylphenyl)dicyclopentadiene, bis[2-(3′-tert-butyl-2′-hydroxy-5′-methylbenzyl)-6-tert-butyl-4-methylphenyl]terephthalate, 1,1-bis-(3,5-dimethyl-2-hydroxyphenyl)buta ne, 2,2-bis(3,5-di-tert-butyl-4-hydroxyphenyl)propane, 2,2-bis-(5-tert-butyl-4-hydroxy-2-methylphenyl)-4-n-dodecylmercaptobutane, 1,1,5,5-tetra(5-tert-butyl-4-hydroxy-2-methylphenyl)pentane;
O-, N- and S-benzyl compounds such as e.g., 3,5,3′,5′-tetra-tert-butyl-4,4′-dihydroxydibenzylether, cctadecyl-4-hydroxy-3,5-dimethylbenzylmercaptoacetate, tridecyl-4-hydroxy-3,5-di-tert-butylbenzylmercaptoacetate, tris(3,5-di-tert-butyl-4-hydroxybenzyl)amine, bis(4-tert-butyl-3-hydroxy-2,6-dimethylbenzyl)dithioterephthalate, bis(3,5-di-tert-butyl-4-hydroxybenzyl)sulfide, isooctyl-3,5-di-tert-butyl-4-hydroxybenzylmercaptoacetate;
hydroxybenzylated malonates, such as e.g., dioctadecyl-2,2-bis(3,5-di-tert-butyl-2-hydroxybenzyl)malonate, dioctadecyl-2-(3-tert-butyl-4-hydroxy-5-methylbenzyl)malonate, didodecylmercaptoethyl-2,2-bis(3,5-di-tert-butyl-4-hydroxybenzyl)malonate, bis[4-(1,1,3,3-tetramethylbutyl)phenyl]-2,2-bis(3,5-di-tert-butyl-4-hydroxybenzyl)malonate;
aromatic hydroxybenzyl compounds, such as e.g., 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol;
triazine compounds, such as e.g., 2,4-bis(octylmercapto)-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris(3,5-di-tert-butyl-4-hydroxybenzyl)isocyanurate, 1,3,5-tris(4-tert-butyl-3-hydroxy-2,6-dimethylbenzyl)isocyanurate, 2,4,6-tris(3,5-di-tert-butyl-4-hydroxphenylethyl)-1,3,5-triazine, 1,3,5-tris(3,5-di-tert-butyl-4-hydroxyphenylpropionyl)hexahydro-1,3,5-triazine, 1,3,5-tris(3,5-dicyclohexyl-4-hydroxybenzyl)isocyanurate;
benzyl phosphonates, such as e.g., dimethyl-2,5-di-tert-butyl-4-hydroxybenzylphosphonate, diethyl-3,5-di-tert-butyl-4-hydroxybenzylphosphonate, dioctadecyl-3,5-di-tert-butyl-4-hydroxybenzylphosphonate, dioctadecyl-5-tert-butyl-4-hydroxy-3-methylbenzylphosphonate, the calcium salt of the monoethylester of 3,5-di-tert-butyl-4-hydroxybenzylphosphonic acid;
acylaminophenols, such as e.g., 4-hydroxylauranilide, 4-hydroxystearanilide, octyl-N-(3,5-di-tert-butyl-4-hydroxyphenyl)carbamate;
esters of β-(3,5-di-tert-butyl-4-hydroxyphenyl)propionic acid with monohydric or polyhydric alcohols, for example methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
esters of β-(5-tert-butyl-4-hydroxy-3-methylphenyl)propionic acid with monohydric or polyhydric alcohols, for example methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane, 3,9-bis[2-{3-(3-tert-butyl-4-hydroxy-5-methylphenyl)propionyloxy}-1,1-dimethylethyl]-2,4,8,10-tetraoxaspiro[5.5]undecane;
esters of β-(3,5-dicyclohexyl-4-hydroxyphenyl)propionic acid with monohydric or polyhydric alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
esters of (3,5-di-tert-butyl-4-hydroxyphenyl)acetic acid with monohydric or polyhydric alcohols, for example methanol, ethanol, octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl)isocyanurate, N,N′-bis(hydroxyethyl)oxamide, 3-thiaundecanol, 3-thiapentadecanol, trimethylhexanediol, trimethylolpropane, 4-hydroxymethyl-1-phospha-2,6,7-trioxabicyclo[2.2.2]octane;
amides of β-(3,5-di-tert-butyl-4-hydroxyphenyl)propionic acid, such as e.g., N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenylpropionyl)hexamethylene diamide, N,N′-bis(3,5-di-tert-butyl-4-hydroxyphenylpropionyl)hydrazide, N,N′-bis[2-(3-[3,5-di-tert-butyl-4-hydroxyphenyl]propionyloxy)ethyl]oxamide (Naugard®XL-1, marketed by Uniroyal);
ascorbic acid (vitamin C).

Particularly preferred phenolic antioxidants are the following structures:

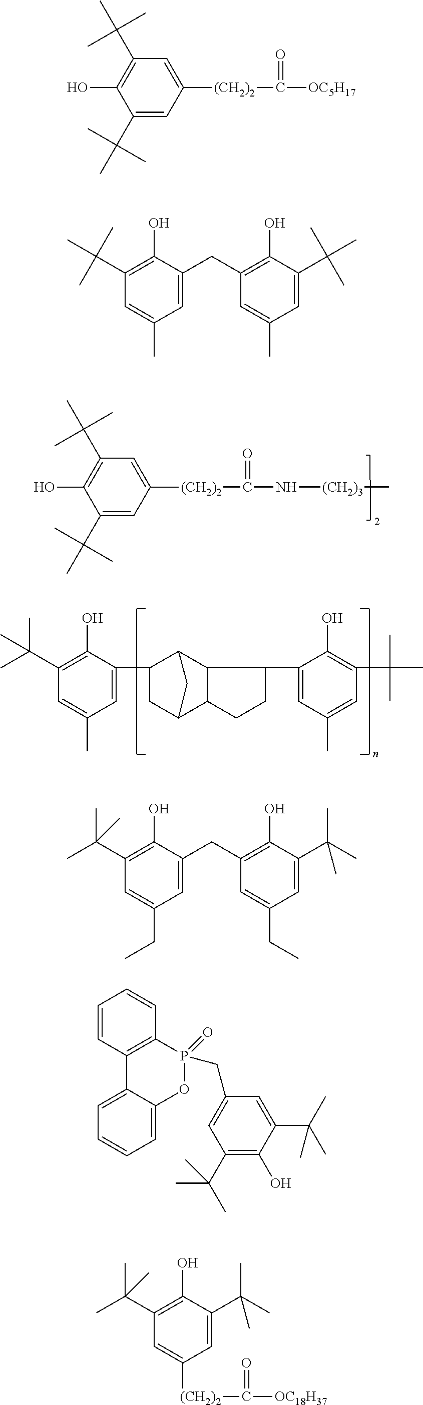

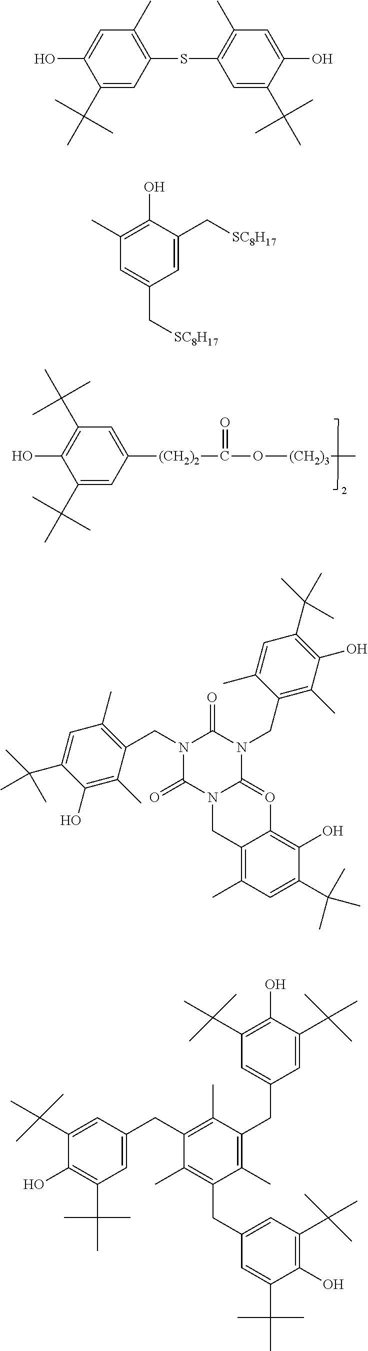

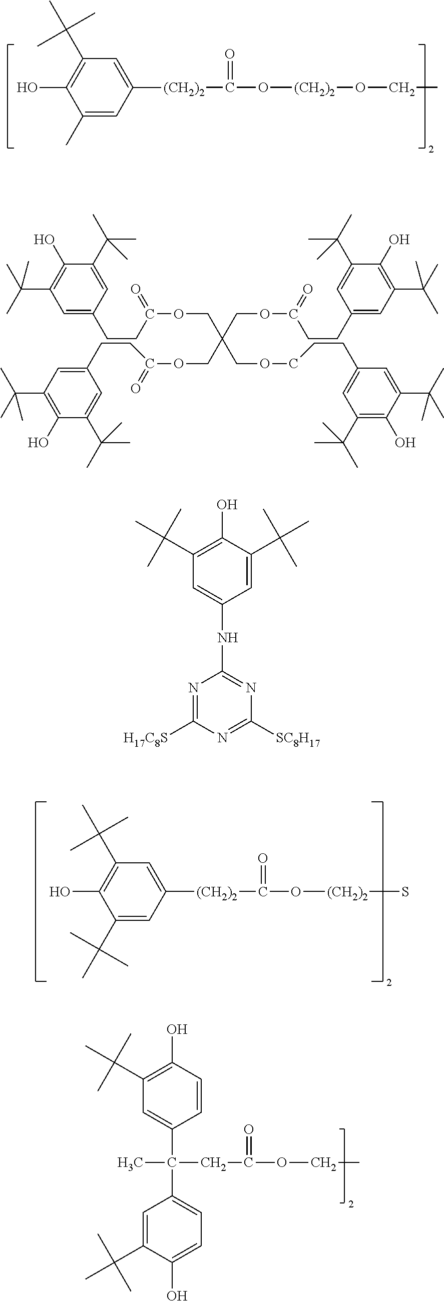

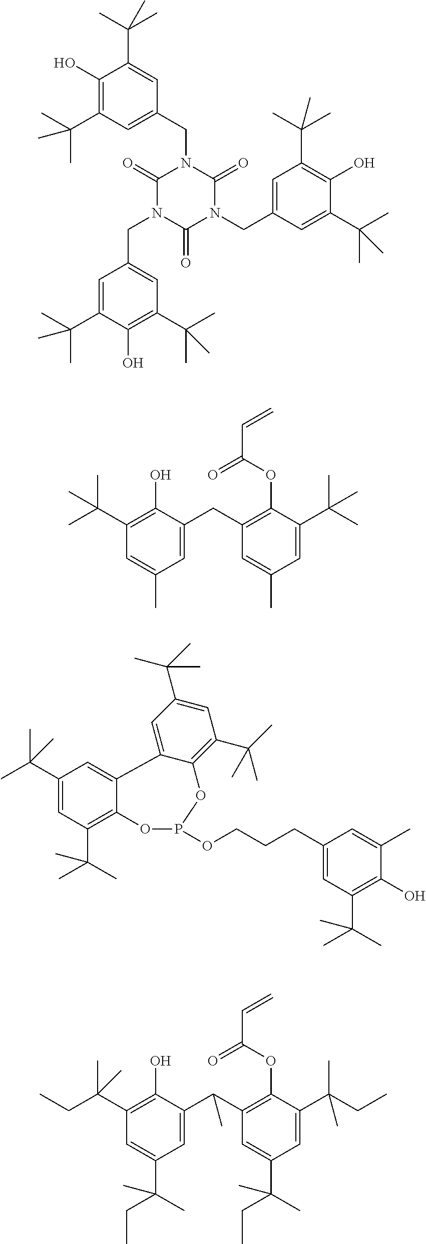

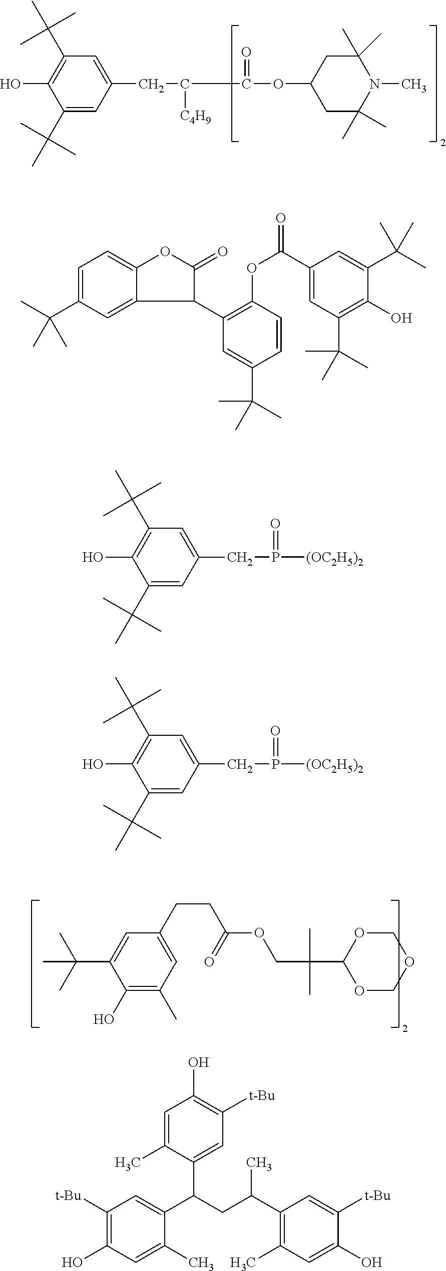

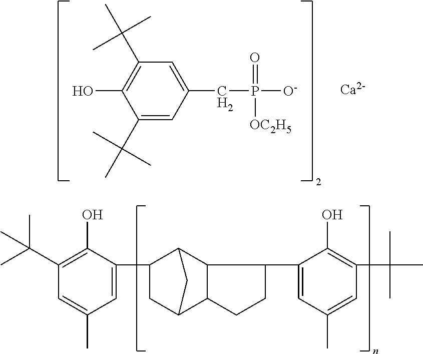

Very particularly preferred phenolic antioxidants are octadecyl-3-(3,5-di-tert-butyl-4-hydroxyphenyl)propionate and pentaerythritol tetrakis(3-(3,5-di-tert-butyl-4-hydroxyphenyl)propionate)

Further particularly preferred phenolic antioxidants are based on sustainable raw materials such as e.g., tocopherols (vitamin E), tocotrienols, tocomonoenols, carotenoids, hydroxytyrosol, flavonols such as e.g., chrysin, quercetin, hesperidin, neohesperidin, naringin, morin, camphor oil, fisetin, anthocyanins such as e.g., delphinidin and malvidin, curcumin, carnosic acid, carnosol, rosmarinic acid, and resveratrol.

Suitable aminic antioxidants are, for example:

N,N′-di-isopropyl-p-phenylene diamine, N,N′-di-sec-butyl-p-phenylene diamine, N,N′-bis(1,4-di methylpentyl)-p-phenylene diamine, N,N′-bis(1-ethyl-3-methylpentyl)-p-phenylene diamine, N N′-bis(1-methylheptyl)-p-phenylene diamine, N,N′-dicyclohexyl-p-phenylene diamine, N,N′-diphenyl-p-phenylene diamine, N,N′-bis(2-naphthyl)-p-phenylene diamine, N-isopropyl-N′-phenyl-p-phenylene diamine, N-(1,3-dimethylbutyl)-N′-phenyl-p-phenylene diamine, N-(1-methylheptyl)-N′-phenyl-p-phenylene diamine, N-cyclohexyl-N′-phenyl-p-phenylene diamine, 4-(p-toluene sulfamoyl)diphenylamine, N,N′-dimethyl-N,N′-di-sec-butyl-p-phenylene diamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, for example p,p′-di-tert-octyldiphenylamine, 4-n-butylaminophenol, 4-butyrylaminophenol, 4-nonanoylaminophenol, 4-dodecanoylaminophenol, 4-octadecanoylamino-phenol, bis(4-methoxyphenyl)amine, 2,6-di-tert-butyl-4-dimethylaminomethyl-phenol, 2,4′-diaminodiphenylmethane, 4,4′-diaminodiphenylmethane, N,N,N′,N′-tetra-methyl-4,4′-diaminodiphenylmethane, 1,2-bis[(2-methyl-phenyl)amino]ethane, 1,2-bis(phenylamino)propane, (o-tolyl)biguanide, bis[4-(1′,3′-dimethylbutyl)phenyl]amine, tert-octylated N-phenyl-1-naphthylamine, a mixture of mono- and dialkylated tert-butyl/tert-octyldiphenylamines, a mixture of mono- and dialkylated nonyldiphenylamines, a mixture of mono- and dialkylated dodecyldiphenylamines, a mixture of mono- and dialkylated isopropyl/isohexyl-diphenylamines, a mixture of mono- and dialkylated tert-butyldiphenylamines, 2,3-dihydro-3,3-dimethyl-4H-1,4-benzothiazine, phenothiazine, a mixture of mono- and dialkylated tert-butyl/tert-octylphenothiazines, a mixture of mono- and dialkylated tert-octylphenothiazinene, N-allylphenothiazine, N,N,N′,N′-tetraphenyl-1,4-diaminobut-2-ene and mixtures or combinations hereof.

Preferred aminic antioxidants are: N,N′-di-isopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpentyl)-p-phenylenediamine, N,N′-bis(1-methylheptyl)-p-phenylenediamine, N,N′-dicyclohexyl-p-phenylenediamine, N,N′-diphenyl-p-phenylenediamine, N,N′-bis(2-naphthyl)-p-phenylenediamine, N-isopropyl-N′-phenyl-p-phenylenediamine, N-(1,3-dimethylbutyl)-N′-phenyl-p-phenylenediamine, N-(1-methylheptyl)-NT-phenyl-p-phenylenediamine, N-cyclohexyl-N′-phenyl-p-phenylenediamine.

Particularly preferred aminic antioxidants are the structures:

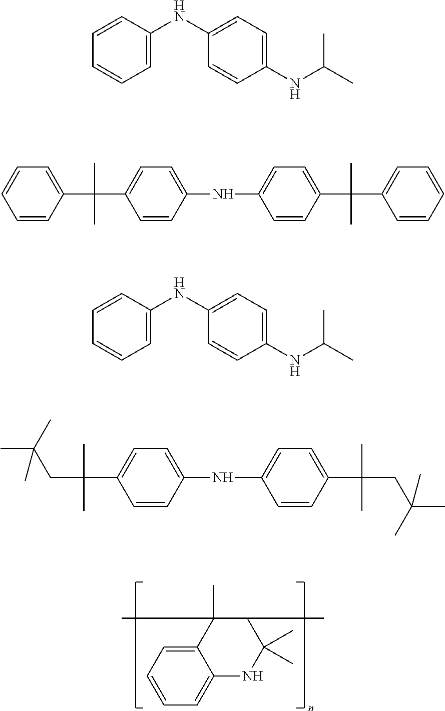

Further preferred aminic antioxidants are hydroxylamines or N-oxides (nitrones), such as e.g., N,N-dialkylhydroxylamines, N,N-dibenzylhydroxylamine, N,N-dilaurylhydroxylamine, N,N-distearylhydroxylamine, N-benzyl-α-phenylnitrone, N-octadecyl-α-hexadecylnitrone, and Genox EP (SI Group) according to the formula:

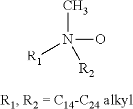

Suitable lactones are benzofuranones and indolinones such as e.g., 3-(4-(2-acetoxyethoxy)phenyl]-5,7-di-tert-butyl-benzofuran-2-one, 5,7-di-tert-butyl-3-[4-(2-stearoyloxyethoxy)phenyl]benzofuran-2-one, 3,3′-bis[5,7-di-tert-butyl-3-(4-(2-hydroxyethoxy]phenyl)benzofuran-2-one), 5,7-di-tert-butyl-3-(4-ethoxyphenyl)benzofuran-2-one, 3-(4-acetoxy-3,5-dimethylphenyl)-5,7-di-tert-butyl-benzofuran-2-one, 3-(3,5-di methyl-4-pivaloyloxyphenyl)-5,7-di-tert-butyl-benzofuran-2-one, 3-(3,4-dimethylphenyl)-3-(2,3-dimethylphenyl)-5,7-di-tert-butyl-benzofuran-2-one as well as lactones that additionally contain a phosphite group such as e.g.,:

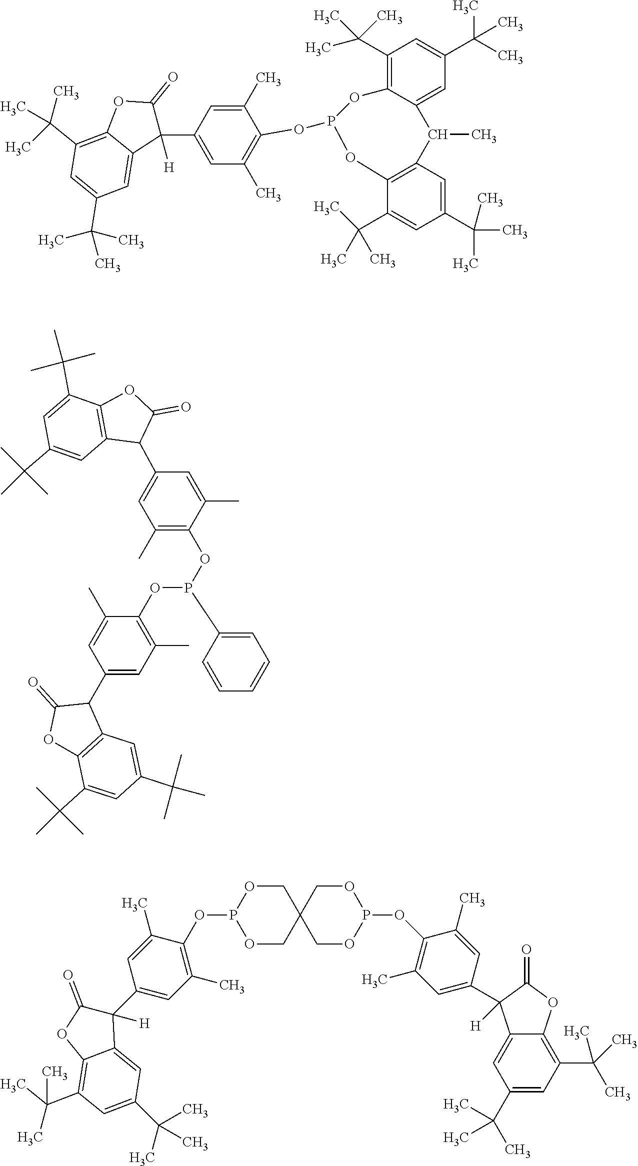

A further suitable group of antioxidants are isoindolol[2,1-A]quiinazoniles such as e.g.,

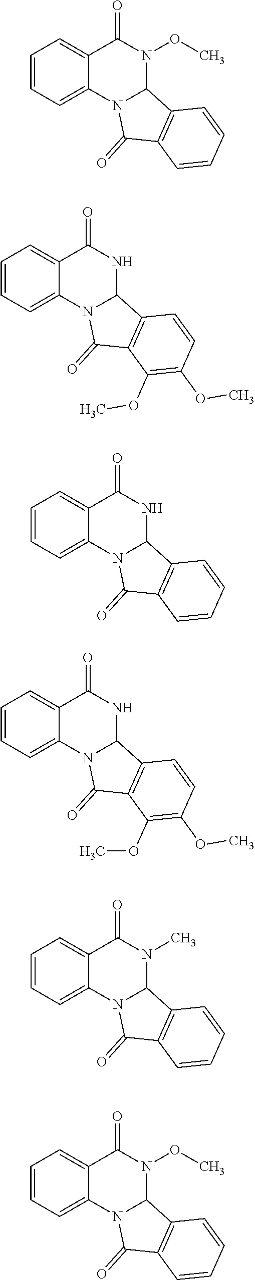

Suitable costabilizers are furthermore polyols, in particular alditols or cyclitols. Polyols are e.g., pentaerythritol, dipentaerythritol, tripentaerythritol, short chain polyether polyols or short chain polyester polyols, and hyperbranched polymers/oligomers, or dendrimers having alcohol groups, e.g.,:

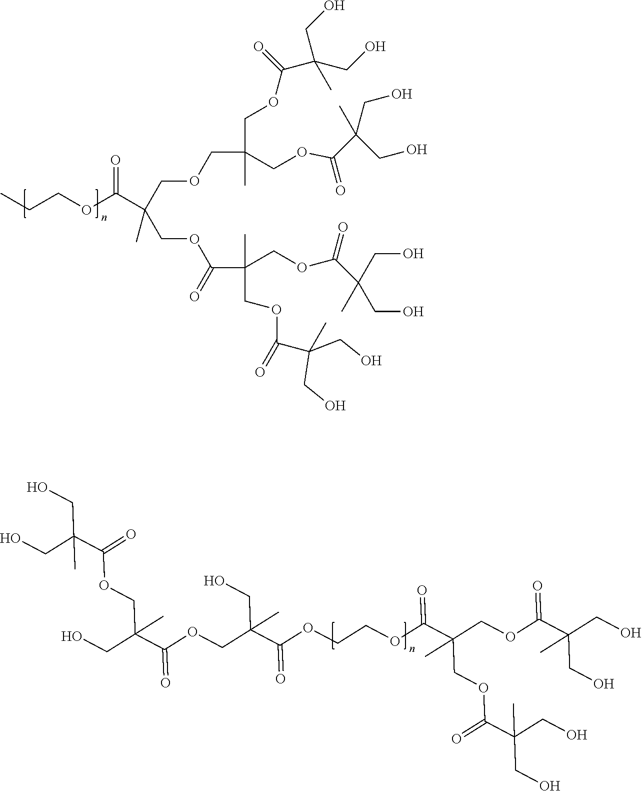

perbranched polymers/oligomers or dendrimers with alcohol groups, e.g.,

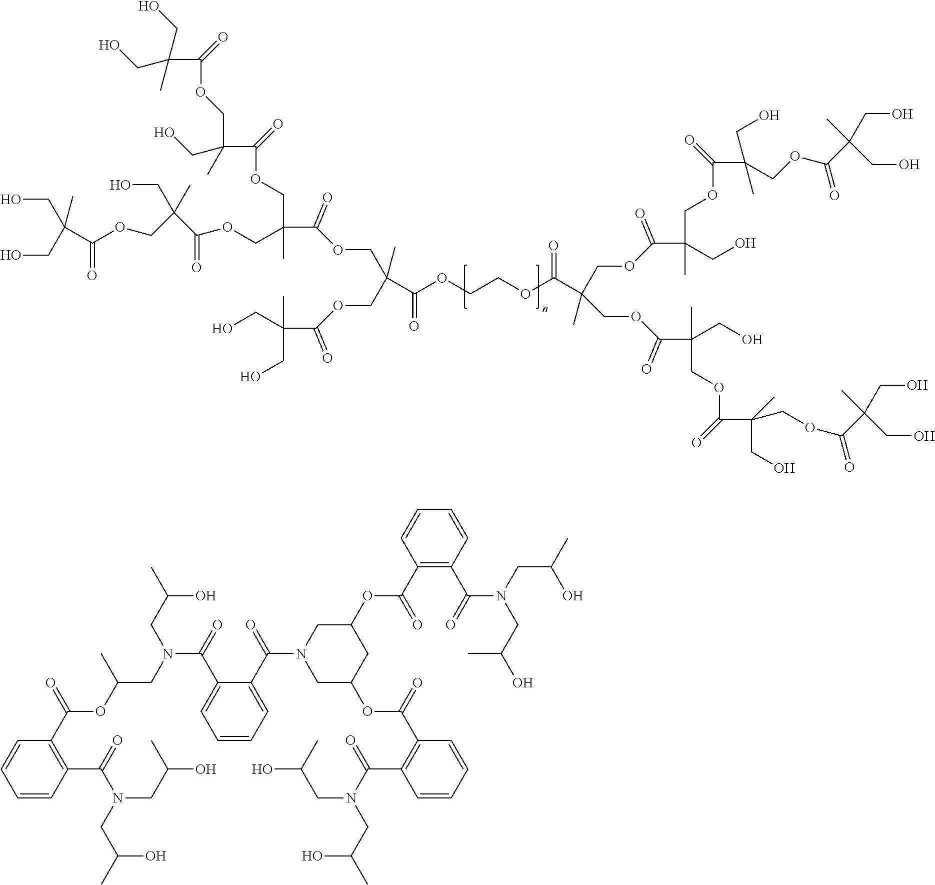

The at least one alditol is preferably selected from the group consisting of threitol, erythritol, galactitol, mannitol, ribitol, sorbitol, xylitol, arabitol, isomalt, lactitol, maltitol, altritol, iditol, maltotritol and hydrogenated oligo- and polysaccharides having polyol end groups and mixtures thereof. The at least one preferred alditol is particularly preferably selected from the group comprising erythritol, mannitol, isomaltol, maltitol, and mixtures thereof.

Examples for further suitable sugar alcohols are heptitols and octitols: meso-glycero-allo-heptitol, D-glycero-D-altro-heptitol, D-glycero-D-manno-heptitol, meso-glycero-gulo-heptitol, D-glycero-D-galacto-heptitol (perseitol), D-glycero-D-gluco-heptitol, L-glycero-D-gluco heptitol, D-erythro-L-galacto-octitol, D-threo-L-galacto-octitol.

The at least one cyclitol can in particular be selected from the group consisting of inositol (myo, scyllo-, D-chiro-, L-chiro-, muco-, neo-, allo-, epi- and cis-inositol), 1,2,3,4-tetra hydroxycyclohexane, 1,2,3,4,5-pentahydroxycyclohexane, quercitol, viscumitol, bornesitol, conduritol, ononitol, pinitol, pinpollitol, quebrachitol, ciceritol, quinic acid, shikimic acid, and valienol, with myo-inositol (myo-inositol) being preferred here.

Suitable light stabilizers are, for example, compounds based on 2-(2′-hydroxyphenyl)benzotriazoles, 2-hydroxybenzophenones, esters of benzoic acids, acrylates, oxamides and 2-(2-hydroxyphenyl)-1,3,5-triazines.

Suitable 2-(2″-hydroxyphenyl)benzotriazoles are, for example, 2-(2′-hydroxy-5′methylphenyl)benzotriazole, 2-(3′,5′-di-tert-butyl-2′-hydroxyphenyl)benzotriazole, 2-(5′-tert-butyl-2′-hydroxy-phenyl)benzotriazole, 2-(2′-hydroxy-5′-(1,1,3,3-tetra methyl butyl)phenyl)benzotriazole, 2-(3′,5′-di-tert-butyl-2′-hydroxyphenyl)-5-chlorobenzotriazole, 2-(3′-tert-butyl-2′-hydroxy-5′-methylphenyl-5-chlorobenzotriazole, 2-(3′-sec-butyl-5′-tert-butyl-2′-hydroxy-phenyl)benzotriazole, 2-(2′-hydroxy-4′-octyloxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, 2-(3′-tert-butyl-2′-hydroxy-5′-(2-octyloxycarbonylethyl)phenyl)-5-chlorobenzotriazole, 2-(3′-tert-butyl-5′-[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; the product of the transesterification of 2-[3′-tert-butyl-5′-(2-methoxycarbonylethyl)-2′-hydroxyphenyl]-2H-benzotriazole with polyethyleneglycol 300; [R—CH₂CH₂—COO—CH₂CH₂-]₂, where R=3′-tert-butyl-4′-hydroxy-5′-2H-benzotriazole-2-ylphenyl, 2-[2′-hydroxy-3′-(α,α-dimethylbenzyl)-5′-(1,1,3,3-tetramethylbutyl)phenyl]benzotriazole, 2-[2′-hydroxy-3′-(1,1,3,3-tetramethylbutyl)-5′-(α,α-dimethylbenzyl)phenyl]benzotriazole.

Suitable 2-hydroxybenzophenones are, for example, 4-hydroxy-, 4-methoxy-, 4-octyloxy-, 4-decyloxy-4-dodecyloxy, 4-benzyloxy, 4,2′,4′-trihydroxy- and 2′-hydroxy-4,4′-dimethyoxy derivatives of the 2-hydroxy benzophenones.

Suitable acrylates are, for example, ethyl-α-cyano-(β,β-diphenylacrylate, isooctyl-α-cyano-β,β-diphenylacrylate, methyl-α-carbomethoxycinna mate, methyl-α-cyano-β-methyl-p-methoxycinnamate, butyl-α-cyano-β-methyl-p-methoxycinnamate, methyl-α-carbomethoxy-p-methoxycinnamate and N-β-carbomethoxy-β-cyanovinyl)-2-methylindoline.

Suitable esters of benzoic acids are, for example, 4-tert-butylphenylsalicylate, phenylsalicylate, octylphenylsalicylate, dibenzoylresorcinol, bis(4-tert-butylbenzoyl)resorcinol, benzoylresorcinol, 2,4-di-tert-butylphenyl-3,5-di-tert-butyl-4-hydroxybenzoate, hexadecyl-3,5-di-tert-butyl-4-hydroxybenzoate, octadecyl-3,5-di-tert-butyl-4-hydroxybenzoate, 2-methyl-4,6-di-tert-butylphenyl-3,5-di-tert-butyl-4-hydroxybenzoate.

Suitable oxamides are, for example, 4,4′-dioctyloxyoxanilide, 2,2′-diethoxyoxanilide, 2,2′-dioctyloxy-5,5′-di-tert-butoxanilide, 2,2′-didodecyloxy-5,5′-di-tert-butoxanilide, 2-ethoxy-2′-ethyloxanilide, N,N′-bis(3-dimethylaminopropyl)oxamide, 2-ethoxy-5-tert-butyl-2′-ethoxanilide and its mixtures with 2-ethoxy-2′-ethyl-5,4′-di-tert-butoxanilide, mixtures of n- and p-methoxy-disubstituted oxanilides and mixtures of o- and p-ethoxy-disubstituted oxanilides.

Suitable 2-(2-hydroxyphenyl)-1,3,5-triazines are, for example, 2,4,6-tris(2-hydroxy-4-octyloxyphenyl)-1,3,5-triazine, 2-(2-hydroxy-4-octyloxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl-1,3,5-triazine, 2-(2-hydroxy-4-dodecyloxyphenyl)-4,6-bis(2,4-dimethylphenyl)-1,3,5-triazine, 2-(2-hydroxy-4-tridecyloxyphenyl)-4,6-bis(2,4-dimethylphenyl)-1,3,5-triazine, 2-[4-hydroxy-4-(2-hydroxy-3-butyloxypropoxy)-phenyl]-4,6-bis(2,4-dimethyl)-1,3,5-triazine, 2-[2-hydroxy-4-(2-hydroxy-3-octyloxypropyloxy)phenyl]-4,6-bis(2,4-dimethyl)-1,3,5-triazine, 2-[4-(dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-di methyl phenyl-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine, 2-{2-hydroxy-4-[3-(2-ethylhexyl-1-oxy)-2-hydroxypropyloxy]phenyl}-4,6-bis(2,4-dimethylphenyl-1,3,5-triazine.

Suitable metal deactivators are, for example, N,N′-diphenyloxamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazole, bis(benzylidene)oxalyldihydrazide, oxanilide, isophthaloyldihydrazide, sebacoyl-bis-phenylhydrazide, N,N′-diacetyladipoyldihydrazide, N,N′-bis(salicyloyl)oxylyldihydrazide, N,N′-bis(salicyloyl)thiopropionyldihydrazide, tris[2-tert-butyl-4-thio(2′-methyl-4′-hydroxy-5′-tert-butyl)-phenyl-5-methyl]phenylphosphite.

Particularly preferred as metal deactivators are:

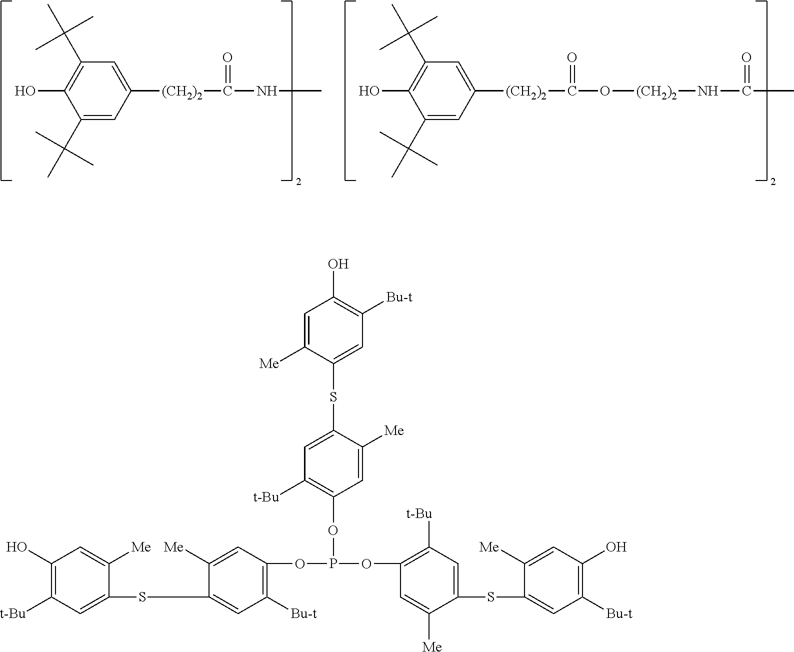

Suitable hindered amines, which are, for example, 1,1-bis(2,2,6,6-tetramethyl-4-piperidyl)succinate, bis(1,2,2,6,6-pentamethyl-4-piperidyl)sebacate, bis(1-octyloxy-2,2,6,6-tetramethyl-4-piperidyl)sebacate, bis(1,2,2,6,6-pentamethyl-4-piperidyl)-n-butyl-3,5-di-tert-butyl-4-hydroxybenzylmalonate, the condensation product of 1-(2-hydroxyethyl)-2,2,6,6-tetramethyl-4-hydroxypiperidine and succinic acid, linear or cyclic condensation products of N,N′-bis(2,2,6,6-tetramethyl-4-piperidyphexamethylenediamine and 4-tert-octylamino-2,6-dichloro-1,3,5-triazine, tris(2,2,6,6-tetramethyl-4-piperidyl)nitrilotriacetate, tetrakis(2,2,6,6-tetra methyl-4-piperidyl)-1,2,3,4-butanetetracarboxylate, 1,1′-(1,2-ethanediyl)-bis(3,3,5,5-tetra methyl piperazinone), 4-benzoyl-2,2,6,6-tetramethylpiperidine, 4-stearyloxy-2,2,6,6-tetramethylpiperidine, linear or cyclic condensation products from N,N′-bis(2,2,6,6-tetramethyl-4-piperidyl)hexamethylenediamine and 4-morpholino-2,6-dichloro-1,3,5-triazine the reaction product of 7,7,9,9-tetramethyl-2-cycloundecyl-1-oxa-3,8-diaza-4-oxospiro-[4,5]decane and epichlorohydrin.

The sterically hindered N—H, N-alkyl such as N-methyl or N-octyl, the N-alkoxy derivatives such as N-methoxy or N-octyloxy, the cycloalkyl derivatives such as N-cyclohexyloxy and the N-(2-hydroxy-2-methylpropoxy) analogs are also each included in the above-given structures here.

Preferred hindered amines also have the following structures:

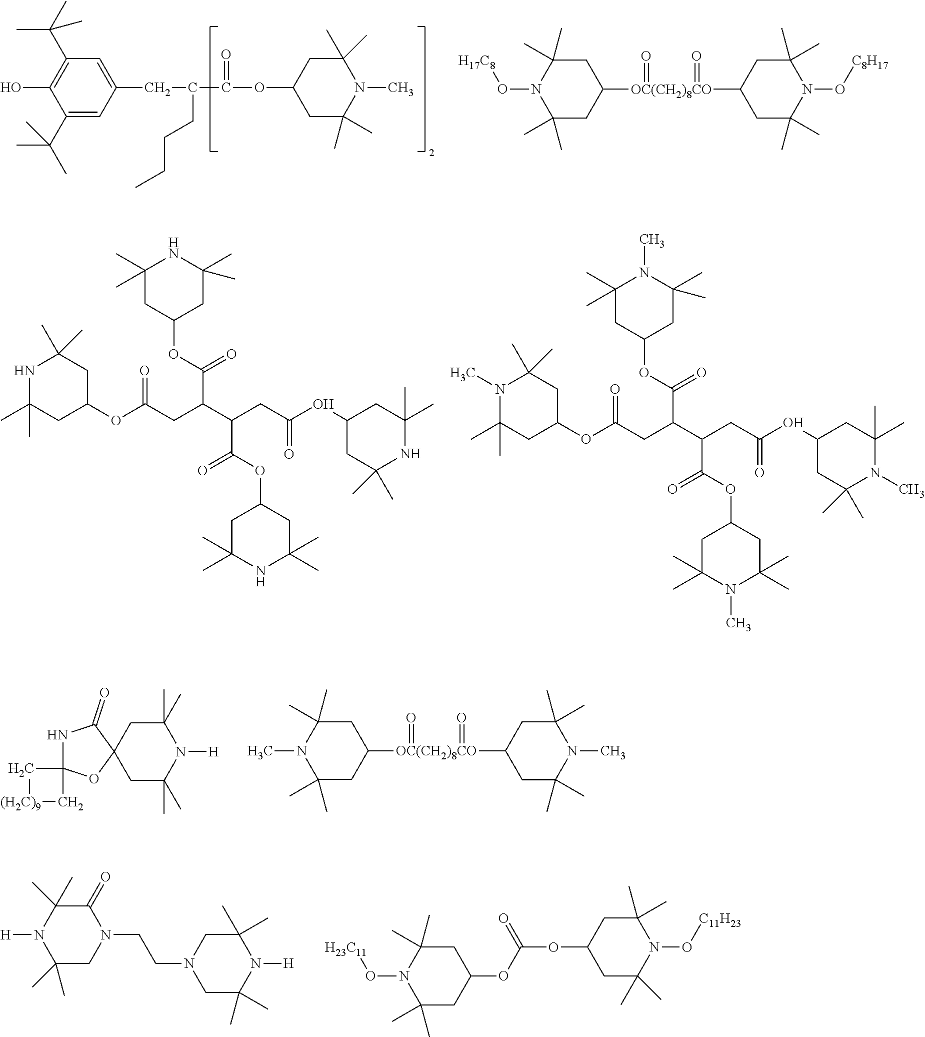

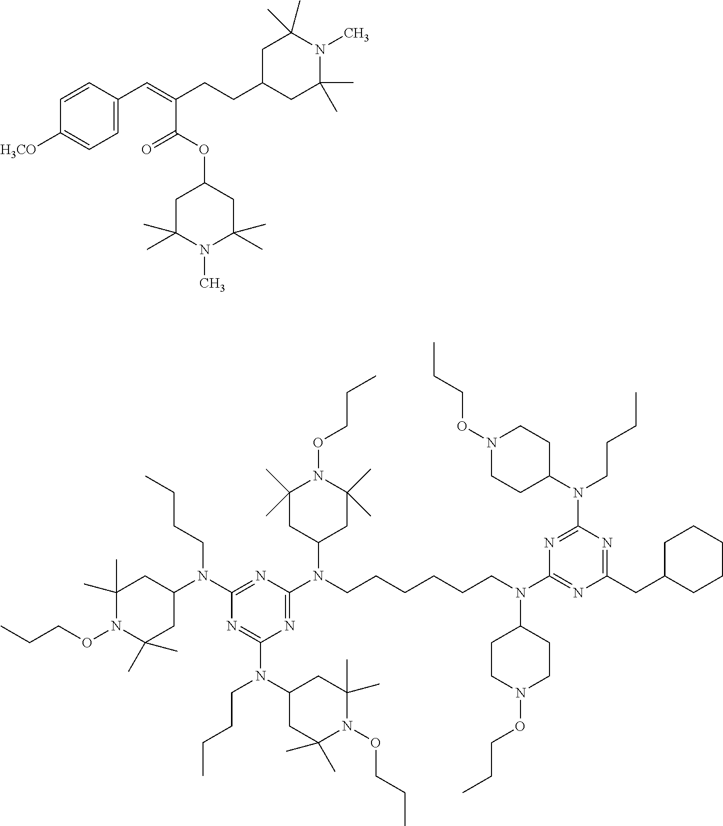 [SMILES: COc1ccc(/C=C(/CCC2CC(C)(C)N(C)C(C)(C)C2)C(=O)OC2CC(C)(C)N(C)C(C)(C)C2)cc1 ; CCCCN(c1nc(CC2CCCCC2)nc(N(CCCCCCN(c2nc(N(CCCC)C3CC(C)(C)N(OCCC)C(C)(C)C3)nc(N(CCCC)C3CC(C)(C)N(OCCC)C(C)(C)C3)n2)C2CC(C)(C)N(OCCC)C(C)(C)C2)C2CCN(OCCC)CC2)n1)C1CCN(OCCC)CC1]

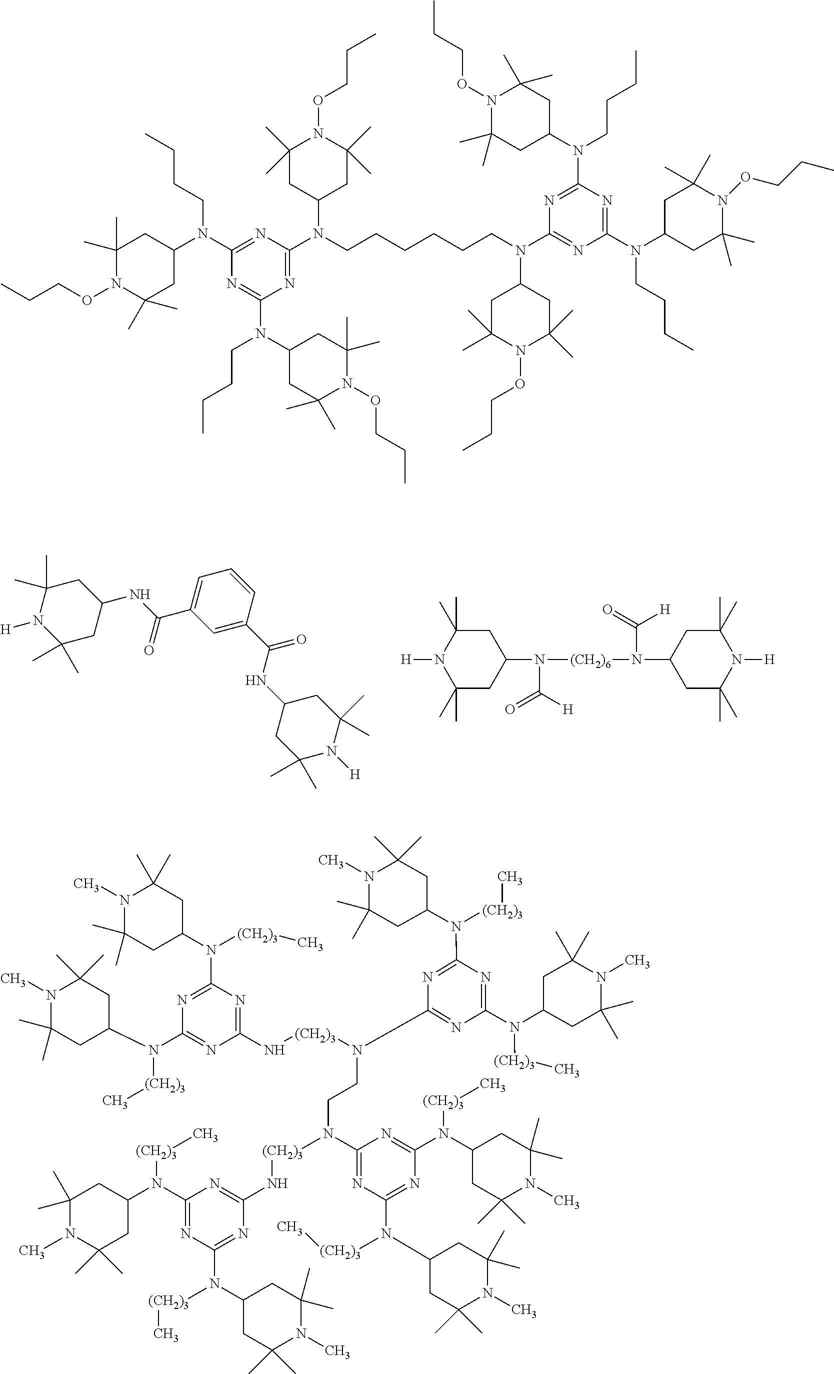

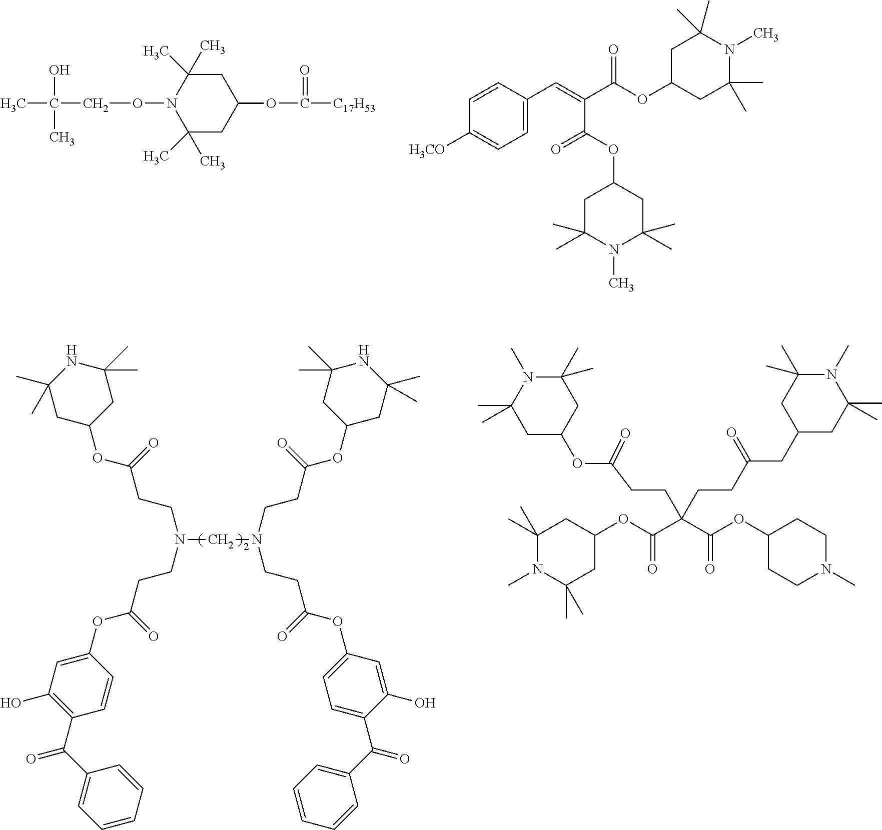

Preferred oligomeric and polymeric hindered amines have the following structures:

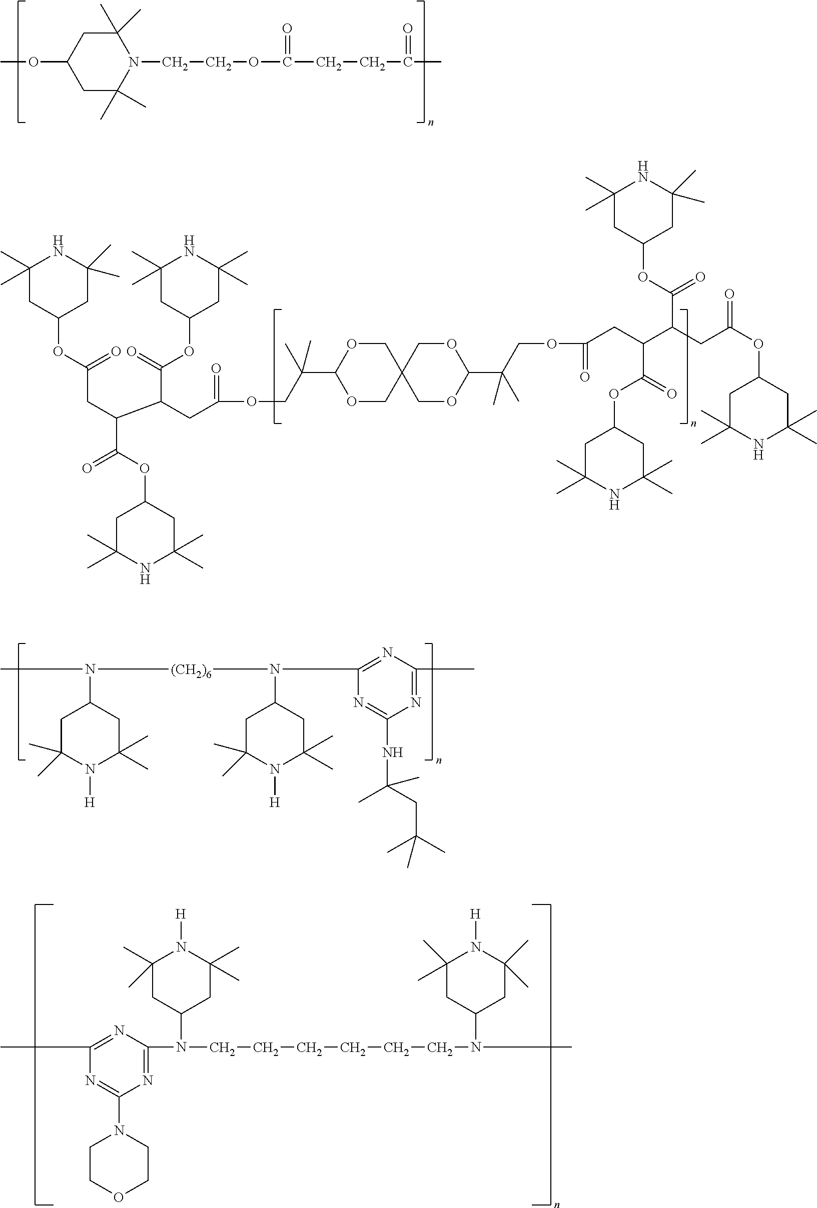

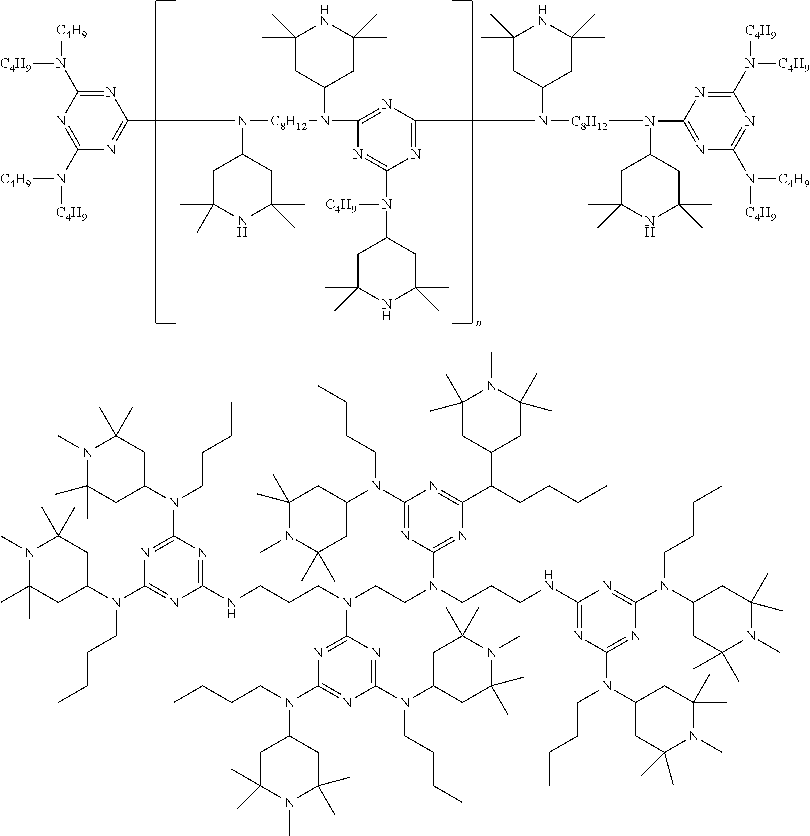

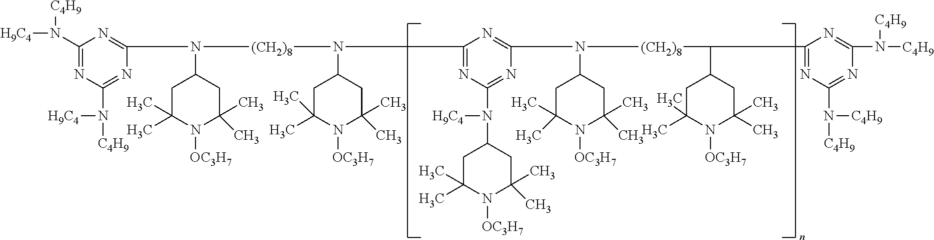

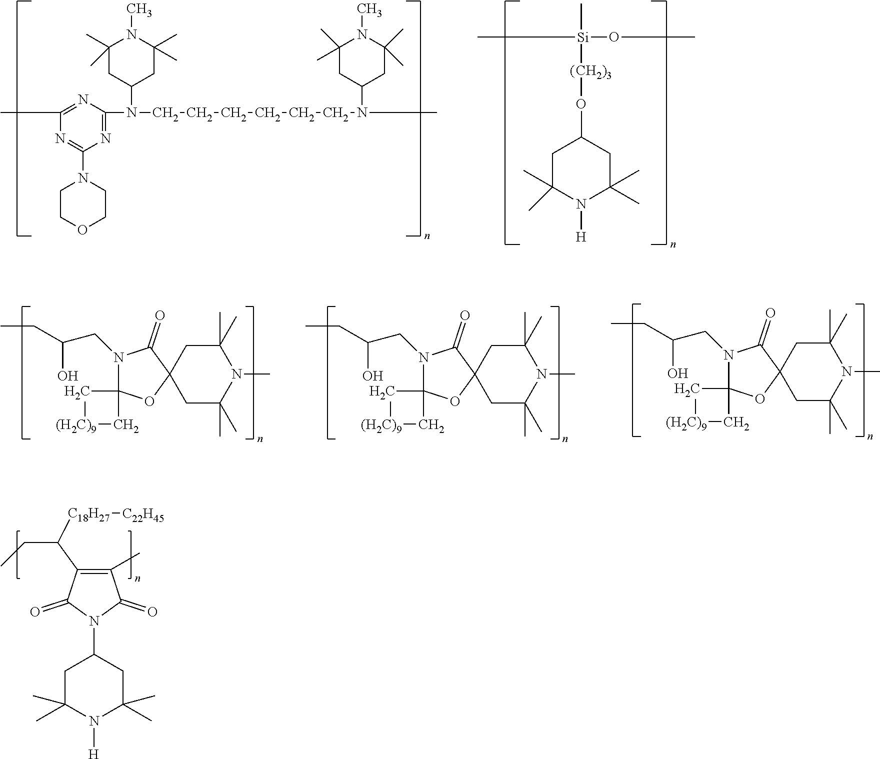

In the above-named compounds, n respectively means 3 to 100.

A further suitable light stabilizer is Hostanox NOW (manufacturer: Clariant SE) with the following general structure:

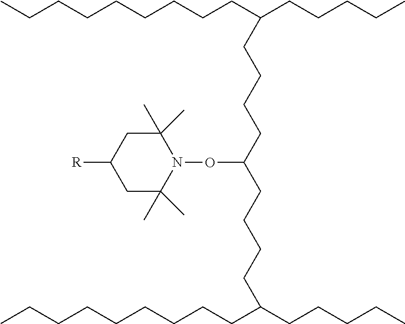

Suitable dispersants are, for example:

polyacrylates, for example, copolymers having long chain side groups, polyacrylate block copolymers, alkylamides: for example, N,N′-1,2-ethanediylbisoctadecanamide sorbitan esters, for example, monostearyl sorbitan esters, titanates and zirconates, reactive copolymers having functional groups, for example, polypropylene-co-acrylic acid, polypropylene-co-maleic anhydride, polyethylene-co-glycidyl methacrylate, polystyrene-alt-maleic anhydride-polysiloxanes: for example, dimethylsilanediol-ethylene oxide copolymer, polyphenylsiloxane copolymer, amphiphilic copolymers: for example, polyethylene block polyethylene oxide, dendrimers, for example, dendrimers comprising hydroxyl groups.

Suitable antinucleation agents are azine dyes such as e.g., nigrosin.

Suitable flame retardant agents are, in particular
inorganic flame retardant agents such as e.g. Al(OH)₃, Mg(OH)₂, AlO(OH), MgCO₃, sheet silicates such as e.g. montmorillonite or sepiolite, unmodified or organically modified double salts such as e.g. Mg—Al silicates, POSS (polyhedral oligomeric silsesquioxanes) compounds, huntite hydromagnesite or halloysite and Sb₂O₃, Sb₂O₅, MoO₃, zinc stannate, zinc hydroxystannate,
flameproofing agents comprising nitrogen such as e.g., melamine, melem, melam, melon, melamine derivatives, melamine condensation products or melamine salts, benzoguanamine, polyisocyanurates, allantoin, phosphacenes, in particular melamine cyanurate, melamine phosphate, dimelamine phosphate, melamine pyrophosphate, melamine polyphosphate, melamine metal phosphates such as e.g., melamine aluminum phosphate, melamine zinc phosphate, melamine magnesium phosphate, and the corresponding pyrophosphates and polyphosphates, poly-[2,4-(piperazine-1,4-yl)-6-(morpholine-4-yl)-1,3,5-triazine], ammonium polyphosphate, melamine borate, melamine hydrobromide,
radical formers such as e.g., alkoxyamines, hydroxylamine esters, azo compounds, triazine compounds, disulfides, polysulfides, thiols, thiuram sulfides, dithiocarbamates, mercaptobenzthiazoles, sulfene amides, sulfene imides,
dicumyl or polycumyl, hydroxyimides and their derivatives such as e.g., hydroxyimide esters or hydroxyimide ethers,
Flame retardant agents containing phosphorus such as e.g., red phosphorus, phosphates such as e.g., resorcin diphosphate, bisphenol-A-diphosphate, and their oligomers, triphenylphosphate, ethylene diamine diphosphate, phosphinates such as e.g., hypophosphorous acid and their derivatives such as alkylphosphinate salts, e.g., diethylphosphinate aluminum or diethylphosphinate zinc or aluminum phosphinate, aluminum phosphite, aluminum phosphonate, phosphonate esters, oligomer and polymer derivatives of the methane phosphonic acid, 9,10-dihydro-9-oxa-10-phosphorylphenanthrene-10-oxide (DOPO) and their substituted compounds,
halogenated flameproofing agents based on chlorine and bromine, such as e.g., polybrominated diphenyl oxides, such as e.g., decabromodiphenyloxide, tris(3-bromo-2,2-bis(bromomethyl)propyl-phosphate, tris(tribromoneopentyl)phosphate, tetrabromophthalic acid, 1,2-bis(tribromophenoxy)ethane, hexa bromocyclododecane, brominated diphenylethane, tris-(2,3-dibrompropyl)isocyanurate, ethylene-bis-(tetrabromophthalimide), tetrabromo-bisphenol A, brominated polystyrene, brominated polybutadiene or polystyrene brominated polybutadiene copolymers, brominated polyphenylene ether, brominated epoxy resin, polypentabromobenzylacrylate, optionally in combination with Sb₂O₃ and/or Sb₂O₅,
borates, such as e.g., zinc borate or calcium borate, optionally on a carrier material, such as e.g., silica
sulfur-comprising compounds, such as e.g., elemental sulphur, disulfides and polysulfides, thiuram sulfide, dithiocarbamates, mercaptobenzothiazole and sulfenamides,
anti-drip agents, such as e.g., polytetrafluoroethylene,
silicon-comprising compounds, such as e.g., polyphenyl siloxanes,
carbon modifications, such as e.g., carbon nanotubes (CNTs), expandable graphite or graphene
and combinations or mixtures thereof.

The following compounds, which are halogen-free, are very particularly preferred flame retardant agents:
Al(OH)₃, Mg(OH)₂,

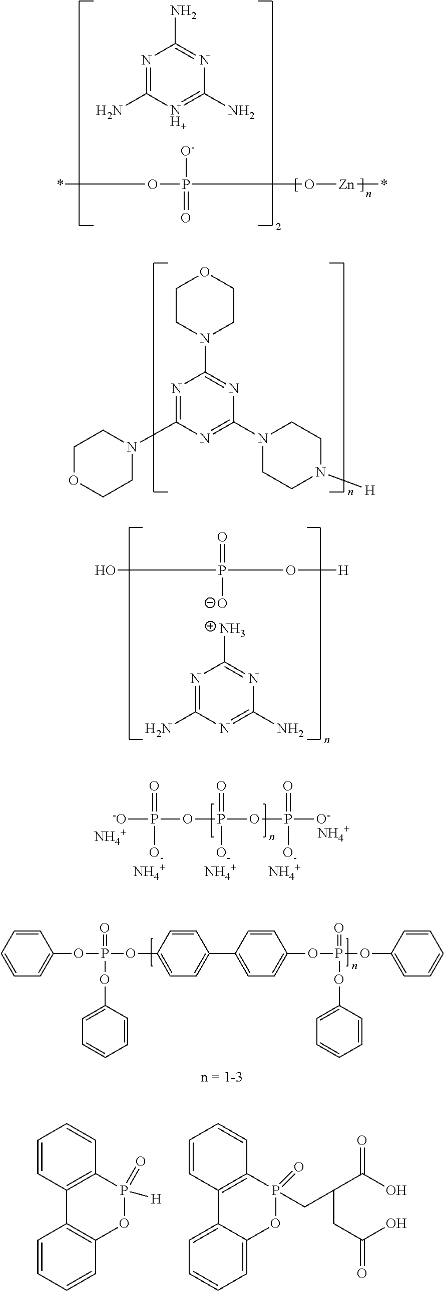

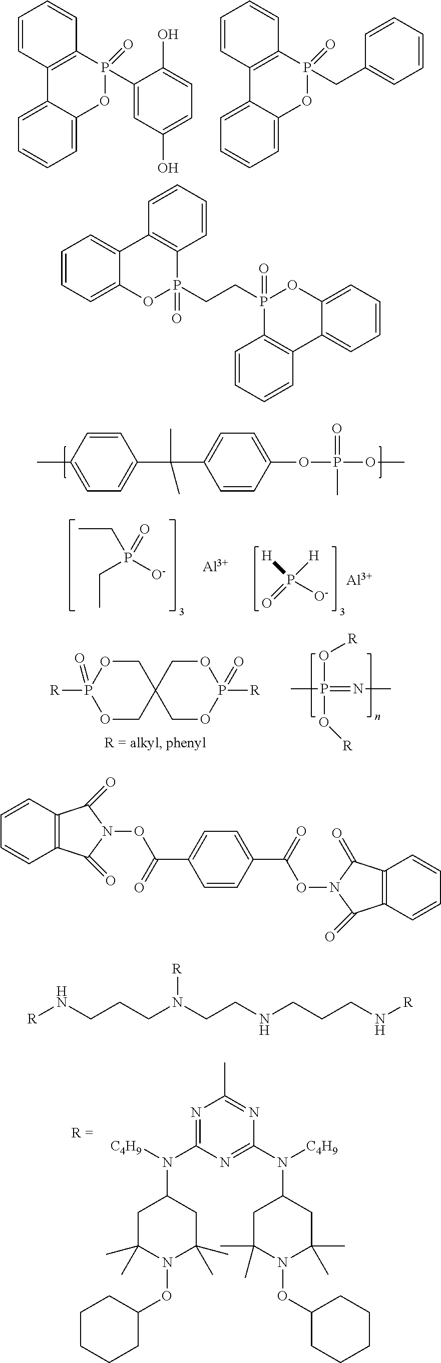

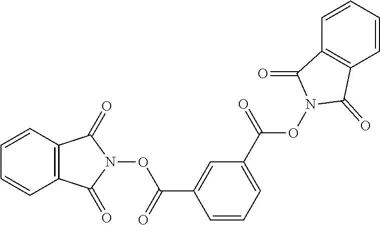 [SMILES: O=C(ON1C(=O)c2ccccc2C1=O)c1cccc(C(=O)ON2C(=O)c3ccccc3C2=O)c1]

Suitable plasticizers are, for example, phthalic acid esters, adipic acid esters, esters of citric acid, esters of 1,2-cyclohexane dicarboxylic acid, trimellitic acid esters, isorobide esters, phosphate esters, epoxides such as e.g., epoxidized soy bean oil, or aliphatic polyesters.

Suitable mold lubricants and processing aids are, for example, polyethylene waxes, polypropylene waxes, salts of fatty acids such as e.g., calcium stearate, zinc stearate, or salts of montane waxes, amide waxes such as e.g., erucic acid amide or oleic acid amides, fluoropolymers, silicones, or neoalkoxytitanates and zirconates.

Suitable pigments may be inorganic or organic. Inorganic pigments are, for example, titanium dioxide, zinc oxide, zinc sulfide, iron oxide, ultramarine, carbon black, organic pigments are, for example, anthraquinones, anthanthrones, benzimidazolones, quinacridones, dketopyrrolopyrrols, dioxazines, indanthrones, isoindolinones, azo compounds, perylenes, phthalocyanines or pyranthrones. Further suitable pigments include effect pigments on a metal basis or pearl gloss pigments on a metal oxide basis.

Suitable optical brighteners are, for example, bis-benzoxazoles, phenylcumarines, or bis(styryl)biphenyls and in particular optical brighteners of the formulas:

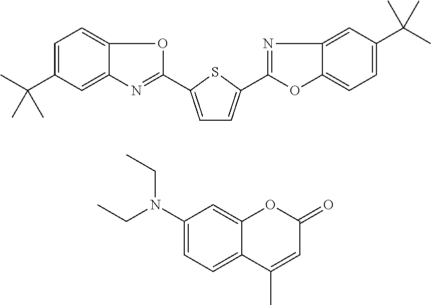

Suitable filler deactivators are, for example, polysiloxanes, polyacrylates, in particular block copolymers such as polymethacrylic acid polyalkyene oxide or polyglycidyl(meth)acrylates and their copolymers, e.g., with styrene and epoxides of e.g., the following structures:

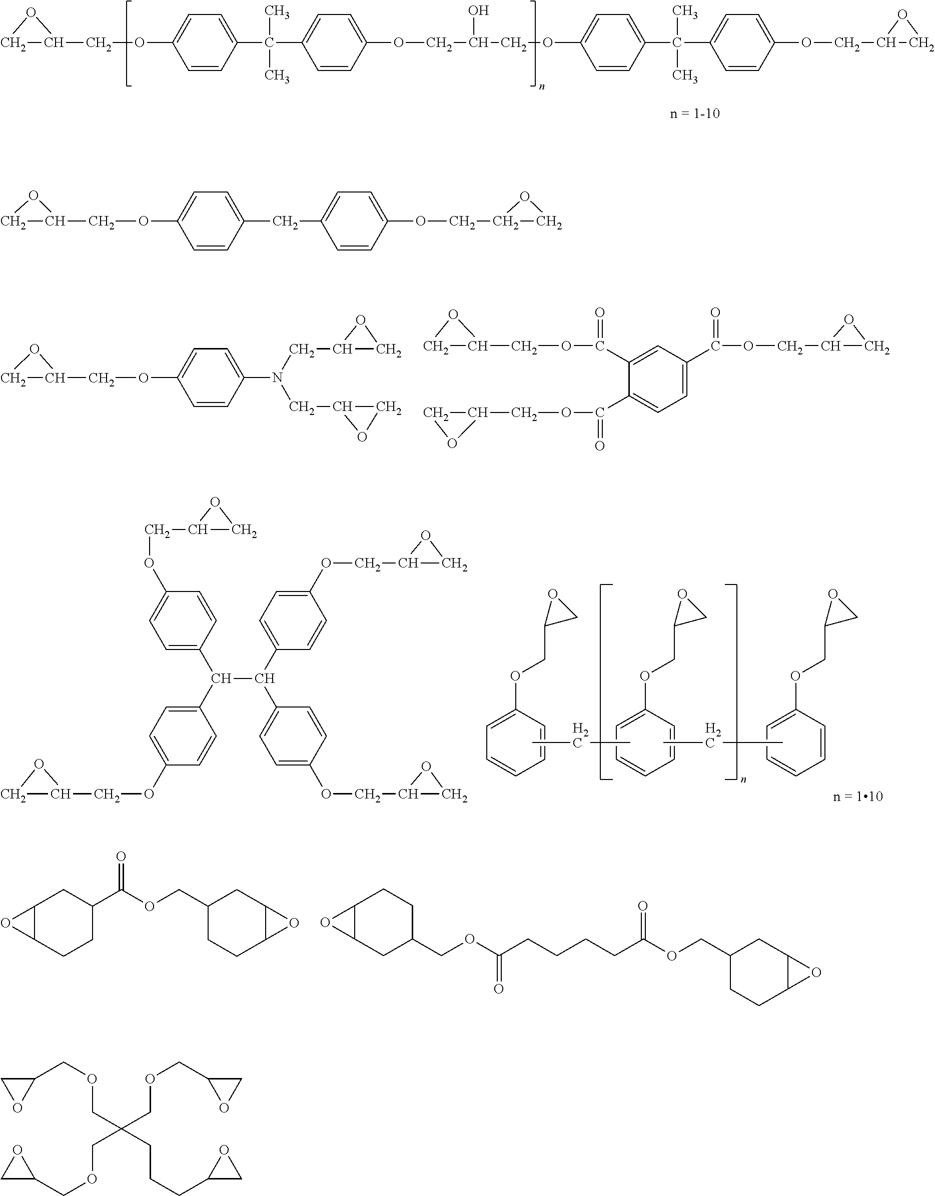

Suitable antistatic agents are, for example, ethoxylated alkylamines, fatty acid esters, alkylsulfonates, and polymers such as e.g., polyetheramides.

Suitable antiozonants are the above-named amines such as e.g., N,N′-di-isopropyl-p-phenylene diamine, N,N′-di-sec-butyl-p-phenylene diamine, N,N′-bis(1,4-dimethylpentyl)-p-phenylene diamine, N,N′-dicyclohexyl-p-phenylene diamine, N-isopropyl-N′-phenyl-p-phenylene diamine, N-(1,3-dimethylbutyl)-NT-phenyl-p-phenylene diamine, N-(1-methylheptyl)-N′-phenyl-p-phenylene diamine, N-cyclohexyl-N′-phenyl-p-phenylene diamine.

Suitable rheology modifications, e.g., for the preparation of controlled rheology polypropylene (CR—PP) are, for example, peroxides, alkoxyaminoesters, oxymide sulfonic acid esters, and in particular the following structures:

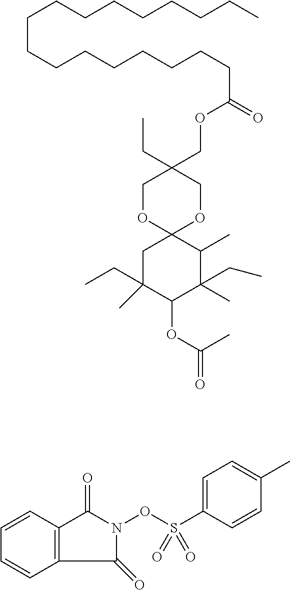 [SMILES: CCCCCCCCCCCCCCCCCC(=O)OCC1(CC)COC2(CC(C)(CC)C(OC(C)=O)C(C)(CC)C2C)OC1 ; Cc1ccc(S(=O)(=O)ON2C(=O)c3ccccc3C2=O)cc1]

Suitable nucleation agents are, talcum, alkali, or alkaline earth salts of mono- and polyfunctional carboxylic acids such as e.g., benzoic acid, succinic acid, adipic acid, e.g., sodium benzoate, zinc glycerolate, aluminiumhydroxy-bis(4-tert-butyl)benzoate, 2,2′-methylene-bis-(4,6-di-tert-butylphenyl)phosphate, and trisamides and diamides such as e.g., trimesic acid tricyclohexylamide, trimesic acid tri(4-methylcyclohexylamide), trimesic acid tri(tert-butylamide), N,N′,N″-1,3,5 benzoltriyltris(2,2-dimethyl-propanamide) or 2,6-naphthalene dicarboxylic acid cyclohexylamide.

Suitable additives for the linear molecular weight structure of polycondensation polymers (chain extenders) are diepoxides, bis-oxazonlines, bis-oxazolones, bis-oxazines, diisoscyanates, dianhydrides, bis-acyllactams, bis-maleimides, dicyanates, carbodiimides. Further suitable chain extenders are polymer compounds such as e.g., polystyrene polyacrylate polyglycidyl(meth)acrylate copolymers, polystyrene maleic acid anhydride copolymers, and polyethylene maleic acid anhydride copolymers.

Suitable additives to increase the electrical conductivity are, for example, the mentioned static inhibitors, black carbon, and carbon compounds such as carbon nanotubes and graphene, metal powders such as e.g., copper powder, and conductive polymers such as e.g., polypyrroles, polyanilines, and polythiopenes. Suitable additives to increase thermal conductivity are, for example, aluminum nitrides and boron nitrides.

Suitable infrared-active additives are, for example, aluminum silicates, hydrotalcites or dyestuffs such as phthalocyanines or anthraquinones.

Suitable crosslinking agents are, for example, peroxides like dialkyl peroxides, alkylaryl peroxides, peroxyesters, peroxycarbonates, diacylproxides, peroxyketals, silanes, such as e.g., vinyltrimethoxysilane, vinyltriethoxysilane, vinyltriacetoxysilane, vinyltris(2-methoxyethoxy)silane, 3-methacryloyloxypropyltrimethoxysilane, vinyldimethoxymethylsilane or ethylene-vinylsilane copolymers.

Suitable prodegradants are additives that specifically accelerate or control the degradation of a polymer in the environment. Examples are transition metal fatty acid esters, for example, of manganese or iron, which accelerate oxidative and/or photooxidative degradation, for example, of polyolefins, or enzymes which induce hydrolytic degradation, for example, of aliphatic polyesters.

Suitable chemical blowing agents are, for example, azo compounds such as azodicarboxylic acid diamide, sulfonyl semicarbazides such as p-toluenesulfonyl semicarbazide, tetrazoles such as 5-phenyl tetrazole, hydrazides such as p-toluenesulfonyl hydrazide, 4,4′-oxibis(benzenesulfonyl)hydrazide, N-nitroso compounds such as N,N′-dinitrosopentamethylene tetramine or carbonates such as e.g., sodium hydrogen carbonate or zinc carbonate.

Suitable slip agents are, for example, amide waxes such as erucic acid amide or oleic acid amide.

Suitable antiblocking agents are, for example, silica, talc or zeolites.

Suitable anti-fogging additives are, for example, ethoxylated sorbitan esters, ethoxylated fatty acid alcohols or ethoxylated alkylamine esters.

Suitable biocides are, for example, quaternary ammonium salts or silver salts, colloidal silver or silver complexes or natural product derivatives, such as e.g., chitosan.

Suitable aldehyde scavengers are amines, hydroxylamines, polyvinyl alcohol, zeolites or cyclodextrins, suitable formaldehyde scavengers are melamine derivatives, such as e.g., benzoguanamine or urea derivatives such as allantoin.

Suitable odor-binding or odor-inhibiting substances are silicates such as calcium silicate, zeolites or salts of hydroxy fatty acids, such as e.g., zinc riceneolate.

Suitable markers are, for example, fluorescent dyes or rare earths.

Suitable additives to increase the thermal conductivity of plastics are, for example, inorganic fillers such as boron nitride, aluminum nitride, aluminum oxide, aluminum silicate, silicon carbode, but also carbon nanotubes (CNT).

Suitable impact modifiers are usually selected for the particular recyclate and are selected for example from the group of functionalized or non-functionalized polyolefins, such as e.g., ethylene copolymers such as EPDM or maleic anhydride or styrene-acrylonitrile-modified EPDM, glycidyl-methacrylate-modified ethylene-acrylate copolymers or also ionomers, core-shell polymers for example based on MBS (methacrylate-butadiene-styrene copolymer) or acrylester-polymethyl methacrylate, thermoplastische elastomers (TPE) for example based on styrene-block copolymers (styrene-butadiene (SB), styrene-butadiene-styrene (SBS) optionally hydrated (SEBS) or modified by maleic anhydride (SEBS-g-MAH), thermoplastic polyurethanes, copolyesters or copolyamides.

Suitable demolding agents are, for example, silicones, soaps, and waxes, such as e.g., montan waxes.

### Methods for Stabilization

The additive according to the invention, i.e., dieugenol, eugenol oligomers and/or eugenol polymers, which can be present as a powder, liquid, oil, compacted, on a carrier material, as granulate, solution or flakes, is preferably mixed with the polymer to be stabilized; the polymer matrix is melted and then cooled. Alternatively to this, it is equally possible to introduce the additive into a polymer melt in a molten state.

In the event that further constituents are added to the polymer composition, these can be added to the polymers separately, in the form of liquids, powders, granules or compacted products or together with the additive composition according to the invention as described above.

The additive composition described above and optionally additional additives are incorporated into the plastic through conventional processing methods, wherein the polymer is melted and mixed with the additive composition according to the invention and the optionally further additives, preferably using mixers, kneaders and extruders. Extruders such as e.g., single screw extruders, twin screw extruders, planetary gear extruders, ring extruders, and co-kneaders that are preferably equipped with a vacuum degassing are preferred as processing machines. The processing can take place under air or optionally under inert gas conditions.

The additive compositions in accordance with the invention can furthermore be prepared and incorporated in a polymer in the form of so-called master batches or concentrates that, for example, include 10-90% of the compositions in accordance with the invention.

The present invention will be described in more detail with reference to the following embodiment without restricting the invention to the specifically shown examples.

### EMBODIMENT

To test the effect of the stabilizers according to the invention, a commercial polypropylene (Moplen HP 500N, Lyondell Basell Industries) was homogenized in a powder-powder mixture with 0.10% dieugenol (test 1), 0.25% dieugenol (test 2) and 0.5% dieugenol (test 3) and circulated in a twin-screw microextruder (MC 5, manufacturer DSM) for 30 minutes at 200° C. and 90 revolutions per minute, and the decrease in force was recorded. The force is a direct measure for the molecular weight of polypropylene; the smaller the reduction, the higher the stabilization effect.

In comparison to a polypropylene without additive, an increased processing stabilization was achieved with increasing concentration of dieugenol, i.e. a greater residual force resulted.

Similarly, a further improvement of the processing stability was obtained by the combination of 0.25% dieugenol with 0.25% of a secondary antioxidant (tris-(2,4-di-tert-butylphenyl)phosphite).

Similarly, a further improvement of the processing stability was obtained by the combination of 0.25% dieugenol with 0.25% of a sulfur-containing secondary antioxidant in the form of methionine.

Similarly, the processing stability of polyethylene, polystyrene, polyamide-6 and a polypropylene-post consumer recyclate was increased by adding 0.25% eugenol.

To test the improved long-term stability, a granulate of polypropylene containing 0.25% dieugenol was stored in a circulating air oven at 135° C. in comparison to a base-stabilized polypropylene (containing 0.05% antioxidants) and the time until the onset of degradation of the polymer was determined by measuring the MVR (Melt Volume Rate) change. Compared to the comparative example, the long-term stability of 100 hours was increased to more than 300 hours.

1-16. (canceled)

17. A method of stabilizing an organic material, the method comprising incorporating into the organic material a stabilizing compound selected from the group consisting of dieugenol, eugenol oligomers, eugenol cooligomers, eugenol polymers, and eugenol copolymers.

18. The method of claim 17, wherein the stabilizing compound provides stabilization against oxidative, thermal, and/or actinic degradation.

19. The method of claim 17, wherein the organic material is selected from the group consisting of coatings lubricants, hydraulic oils, engine oils, turbine oils, transmission oils, metal machining fluids, chemicals, monomers, and combinations thereof.

20. The method claim 17, wherein the dieugenol has the following structure

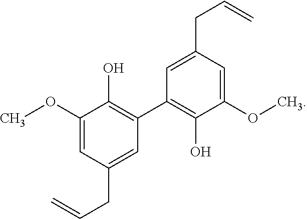 [SMILES: C=CCc1cc(OC)c(O)c(-c2cc(CC=C)cc(OC)c2O)c1]

21. The method of claim 17, wherein the eugenol oligomer or eugenol polymer has one of the following formulas: 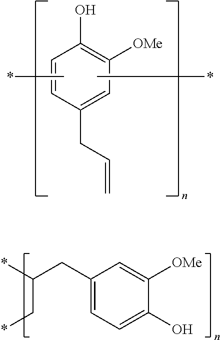
wherein n is an integer from 3 to 100.

22. The method of claim 17, wherein the eugenol cooligomer and/or eugenol copolymer has repetition units A and B or is formed therefrom:
wherein A has the following formula: 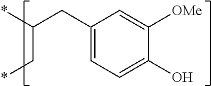
and B is at least one repetition unit derived from a radically, anionically, cationically, or coordinatively polymerizable monomer.

23. The method of claim 22, wherein the polymerizable monomer is selected from the group consisting of ethylene, propylene, butadiene, isoprene, styrene, alpha-methylstyrene, acrylic acid ester, methacrylic ester, hydroxyethyl methacrylate, lauryl methacrylate, stearyl methacrylate, acrylonitrile, mixtures and combinations hereof.

24. The method of claim 22, wherein
the molar ratio of repetition unit A to the total of all repetition units is from 3% to 99.99%, and/or
the total of repetition units A is 3 to 100 and the total of all repetition units B is 1 to 100.

25. The method of claim 22, wherein the dieugenol, eugenol oligomers, eugenol cooligomers, eugenol polymers and/or eugenol copolymers is/are contained in the organic material in a weight proportion of 0.01 to 10.00% by weight.

26. A method of stabilizing a plastic, the method comprising incorporating into the plastic a stabilizing compound selected from the group consisting of dieugenol, eugenol oligomers, eugenol cooligomers, eugenol polymers, and eugenol copolymers, wherein the plastic is selected from the group consisting of
a) polymers of olefins, polymers of diolefins, polyalkylene-carbon monoxide copolymers, copolymers in the form of random or block structures, ethylene-vinyl acetate (EVA), ethylene acrylic esters, ethylene acrylic acid and salts thereof (ionomers), terpolymers, graft polymers, polymer blends also long-chain branched polypropylene copolymers which are produced with alpha-olefins as comonomers,
b) polystyrene, polymethylstyrene, poly-alpha-methyl styrene, polyvinylnaphthalene, polyvinylbiphenyl, polyvinyltoluene, styrene-butadiene (SB), styrene-butadiene-styrene (SBS), styrene-ethylene-butylene-styrene (SEBS), styrene-ethylene-propylene-styrene, styrene-isoprene, styrene-isoprene-styrene (SIS), styrene-butadiene-acrylonitrile (ABS), styrene-acrylonitrile (SAN), styrene-acrylonitrile-acrylate (ASA), styrene-ethylene, styrene-maleic anhydride polymers including corresponding graft copolymers, graft copolymers made of methyl methacrylate, styrene-butadiene and ABS (MABS), and hydrogenated polystyrene derivatives,
c) halogen-comprising polymers, copolymers of vinyl chloride and vinylidene chloride or of vinyl chloride and vinyl acetate, chlorinated polyethylene, polyvinylidene fluoride, and epichlorohydrin homo and copolymers with ethylene oxide (ECO),
d) polymers of unsaturated esters, polyacrylonitrile, polyacrylamide, and polyacrylonitrile-polyalkyl acrylate,
e) polymers of unsaturated alcohols and derivatives thereof and polyallyl melamine,
f) polyacetals, polyphenylene oxides, and blends with polystyrene or polyamides,
g) polymers of cyclic ethers,
h) polyphenylene oxides and blends thereof with polystyrene and/or polyamides,
i) polyurethanes made from hydroxy-terminated polyethers or polyesters and aromatic or aliphatic isocyanates, and polyureas,
j) polyamides, blends of polyamides, and blends of polyamides and polyolefins,
k) polyamide-imides, polyetherimides, polyesterimides, poly(ether)ketones, polysulfones, polyethersulfones, polyarylsulfones, polyphenylene sulfides, polybenzimidazoles, and polyhydantoins,
l) polyesters made from aliphatic or aromatic dicarboxylic acids and diols or from hydroxycarboxylic acids, and polycaprolactone,
m) polycarbonates, polyester carbonates, and blends,
n) cellulose nitrate, cellulose acetate, cellulose propionate, and cellulose butyrate,
o) epoxy resins consisting of di- or polyfunctional epoxy compounds in combination with hardeners based on amines, anhydrides, dicyandiamide, mercaptans, isocyanates or catalytically active hardeners,
p) phenol resins, urea formaldehyde resins, and melamine formaldehyde resins,
q) unsaturated polyester resins from unsaturated dicarboxylic acids and diols with vinyl compounds, and alkyd resins,
r) silicones,
s) and mixtures, combinations, or blends of two or more of the above-named polymers.

27. The method of claim 26, wherein the plastic comprises at least one additional additive selected from the group consisting of primary and/or secondary antioxidants, UV absorbers, light stabilizers, hydroxylamine-based stabilizers, benzofuranone-based stabilizers, nucleating agents, impact modifiers, plasticizers, mold lubricants, rheology modifiers, chain extenders, processing aids, pigments, dyes, optical brighteners, antimicrobial agents, antistatic agents, slip agents, antiblocking agents, coupling agents, dispersants, compatibilizers, oxygen scavengers, acid scavengers, co-stabilizers, marking agents, and anti-fogging agents.

28. The method of claim 27, wherein the secondary antioxidants are selected from the group consisting of phosphites, phosphonites, hindered amines and/or combinations thereof.

29. The method of claim 26, wherein the at least one additive is incorporated in an amount of 0.01 to 9.99% by weight, based on the total of the dieugenol, the eugenol oligomers, eugenol cooligomers, eugenol polymers and/or eugenol copolymers, the organic material, and the at least one additive.

30. An organic material composition containing at least one organic material and a stabilizer or stabilizers selected from the group consisting of dieugenol, eugenol oligomers, eugenol cooligomers, eugenol polymers, and eugenol copolymers.

31. The organic material composition of claim 30, having the following composition:
0.01 to 10.00% by weight of dieugenol, eugenol oligomers, eugenol cooligomers, eugenol polymers and/or eugenol copolymers,
99.99 to 90.00% by weight of at least one organic material, and
0 to 9.99% by weight of at least one additive,
wherein the components add up to 100% by weight.

32. The organic material composition of claim 31, wherein the at least one additive is selected from the group consisting of primary antioxidants, secondary antioxidants, UV absorbers, light stabilizers, stabilizers based on a hydroxylamine base, stabilizers based on a benzofuranone base, nucleating agents, toughness improvers, plasticizers, mold lubricants, rheological modifiers, chain extenders, processing aids, pigments, dyes, optical brighteners, antimicrobial active agents, antistatic agents, slip agents, anti-blocking agents, coupling agents, dispersing agents, compatibilizers, oxygen scavengers, acid scavengers, costabilizers, marking agents, and anti-fogging agents.

33. A stabilizer composition comprising:
dieugenol, eugenol oligomers, eugenol cooligomers, eugenol polymers and/or eugenol copolymers and mixtures and combinations thereof, and
a secondary antioxidant selected from the group consisting of phosphites, phosphonites, or thiols, and/or at least one costabilizer selected from the group consisting of polyols, acid scavengers, or sterically hindered amines, and mixtures and combinations thereof.

34. The stabilizer composition of claim 33, wherein the dieugenol, oligoeugenol or polyeugenol and the at least one secondary antioxidant and/or the costabilizer are present in a ratio by weight from 100:1 to 1:100.
